(19) United States
(12) Patent Application Publication
(10) Pub. No.: US 2025/0112259 A1
(43) Pub. Date: Apr. 3, 2025

(54) SECONDARY BATTERY AND BATTERY PACK

(71) Applicant: MURATA MANUFACTURING CO., LTD., Kyoto (JP)

(72) Inventor: Toshikazu NAKAMURA, Kyoto (JP)

(21) Appl. No.: 18/826,886

(22) Filed: Sep. 6, 2024

(30) Foreign Application Priority Data
Sep. 29, 2023 (JP) 2023-169648

(51) Int. Cl. H01M 10/04; H01M 10/42; H01M 50/107; H01M 50/152; H01M 50/533; H01M 50/534

(52) U.S. Cl. CPC H01M 10/0472; H01M 10/0422; H01M 10/0431; H01M 10/4257; H01M 50/107; H01M 50/152; H01M 50/533; H01M 50/534

(57) ABSTRACT

A secondary battery is provided and includes a first electrode wound body, a second electrode wound body, and an outer package body. The outer package body contains the first electrode wound body and the second electrode wound body. Each of the first electrode wound body and the second electrode wound body includes, at respective ends of a stacked body in a width direction, a first end face at which a first electrode is exposed and a second end face at which a second electrode is exposed. The first electrode wound body and the second electrode wound body are disposed adjacent to each other in the width direction of the stacked body, with the first end face of the first electrode wound body and the first end face of the second electrode wound body being opposed to each other.

### CROSS-REFERENCE TO RELATED APPLICATIONS

The present application claims priority from Japanese Patent Application No. 2023-169648, filed on Sep. 29, 2023, the entire contents of which are hereby incorporated by reference.

### BACKGROUND

The present disclosure relates to a secondary battery, and to a battery pack that includes the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

For example, a secondary battery is proposed in which what is called a tabless structure is employed. Such a secondary battery achieves a reduced internal resistance and allows for charging and discharging with a relatively large current.

### SUMMARY

A secondary battery according to an embodiment of the present disclosure includes a first electrode wound body, a second electrode wound body, and an outer package body. The first electrode wound body and the second electrode wound body each include a wound structure and each have a through hole.

The wound structure includes a stacked body that includes a first electrode, a second electrode, and a separator and that is wound along a longitudinal direction of the stacked body. The through hole is provided through corresponding one of the first electrode wound body and the second electrode wound body in a width direction of the stacked body orthogonal to the longitudinal direction. The outer package body contains the first electrode wound body and the second electrode wound body.

Each of the first electrode wound body and the second electrode wound body includes, at respective ends of the stacked body in the width direction, a first end face at which the first electrode is exposed and a second end face at which the second electrode is exposed. The first electrode wound body and the second electrode wound body are disposed adjacent to each other in the width direction of the stacked body, with the first end face of the first electrode wound body and the first end face of the second electrode wound body being opposed to each other.

A battery pack according to an embodiment of the present disclosure includes a secondary battery, a processor, and an outer package member. The processor is configured to control the secondary battery. The outer package member contains the secondary battery. The secondary battery includes a first electrode wound body, a second electrode wound body, and an outer package body. The first electrode wound body and the second electrode wound body each include a wound structure and each have a through hole. The wound structure includes a stacked body that includes a first electrode, a second electrode, and a separator and that is wound along a longitudinal direction of the stacked body. The through hole is provided through corresponding one of the first electrode wound body and the second electrode wound body in a width direction of the stacked body orthogonal to the longitudinal direction. The outer package body contains the first electrode wound body and the second electrode wound body. Each of the first electrode wound body and the second electrode wound body includes, at respective ends of the stacked body in the width direction, a first end face at which the first electrode is exposed and a second end face at which the second electrode is exposed. The first electrode wound body and the second electrode wound body are disposed adjacent to each other in the width direction of the stacked body, with the first end face of the first electrode wound body and the first end face of the second electrode wound body being opposed to each other.

### BRIEF DESCRIPTION OF THE FIGURES

The accompanying drawings are included to provide a further understanding of the present disclosure and are incorporated in and constitute a part of this specification. The drawings illustrate an embodiment and, together with the specification, serve to explain the principles of the present disclosure.

FIG. 1 is a sectional diagram illustrating a configuration example of a vertical sectional structure of a secondary battery according to an embodiment of the present disclosure along a height direction.

FIG. 2 is a schematic diagram illustrating a configuration example of a stacked body including a positive electrode, a negative electrode, and a separator illustrated in FIG. 1.

FIG. 3 is a sectional diagram illustrating a configuration example of a horizontal sectional structure of an electrode wound body illustrated in FIG. 1.

FIG. 4A is a developed view of the positive electrode illustrated in FIG. 1.

FIG. 4B is a sectional view of the positive electrode illustrated in FIG. 1.

FIG. 5A is a developed view of the negative electrode illustrated in FIG. 1.

FIG. 5B is a sectional view of the negative electrode illustrated in FIG. 1.

FIG. 6A is a plan view of a positive electrode current collector plate illustrated in FIG. 1.

FIG. 6B is a plan view of a negative electrode current collector plate illustrated in FIG. 1.

FIGS. 7A to 7D are each a perspective diagram describing a process of manufacturing the secondary battery illustrated in FIG. 1.

FIGS. 8A to 8C are each a perspective diagram describing a process of manufacturing the secondary battery, following the process illustrated in FIG. 7D.

FIG. 9 is a block diagram illustrating a circuit configuration of a battery pack to which the secondary battery according to an embodiment of the present disclosure is applied.

FIG. 10 is a sectional diagram illustrating a configuration example of a vertical sectional structure, along a height direction, of a secondary battery according to a modification example of an embodiment of the present disclosure.

FIG. 11A is a characteristic diagram illustrating a discharge load characteristic of Example 1.

FIG. 11B is a characteristic diagram illustrating a discharge load characteristic of Comparative example 1.

### DETAILED DESCRIPTION

Consideration has been given in various ways to improve performance of a secondary battery. There is, however, still room for improvement in terms of the performance of the secondary battery.

It is desirable to provide a secondary battery that has a reduced internal resistance, and to provide a battery pack that includes such a secondary battery according to an embodiment.

In the following, one or more embodiments of the present disclosure are described in detail with reference to the accompanying drawings. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following an embodiment which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to an embodiment of the present disclosure.

In an embodiment, a cylindrical lithium-ion secondary battery having an outer appearance of a cylindrical shape will be described as an example. However, a secondary battery of an embodiment of the present disclosure is not limited to the cylindrical lithium-ion secondary battery, and may be a lithium-ion secondary battery having an outer appearance of a shape other than the cylindrical shape, or may be a secondary battery in which an electrode reactant other than lithium is used.

Although a charge and discharge principle of the secondary battery is not particularly limited, the following description deals with a case where a battery capacity is obtained through insertion and extraction of the electrode reactant. The secondary battery may include a positive electrode, a negative electrode, and an electrolyte. In the secondary battery, to prevent precipitation of the electrode reactant on a surface of the negative electrode during charging, a charge capacity of the negative electrode may be greater than a discharge capacity of the positive electrode. For example, an electrochemical capacity per unit area of the negative electrode may be set to be greater than an electrochemical capacity per unit area of the positive electrode.

The electrode reactant is not particularly limited in kind, as described above. For example, the electrode reactant may be a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

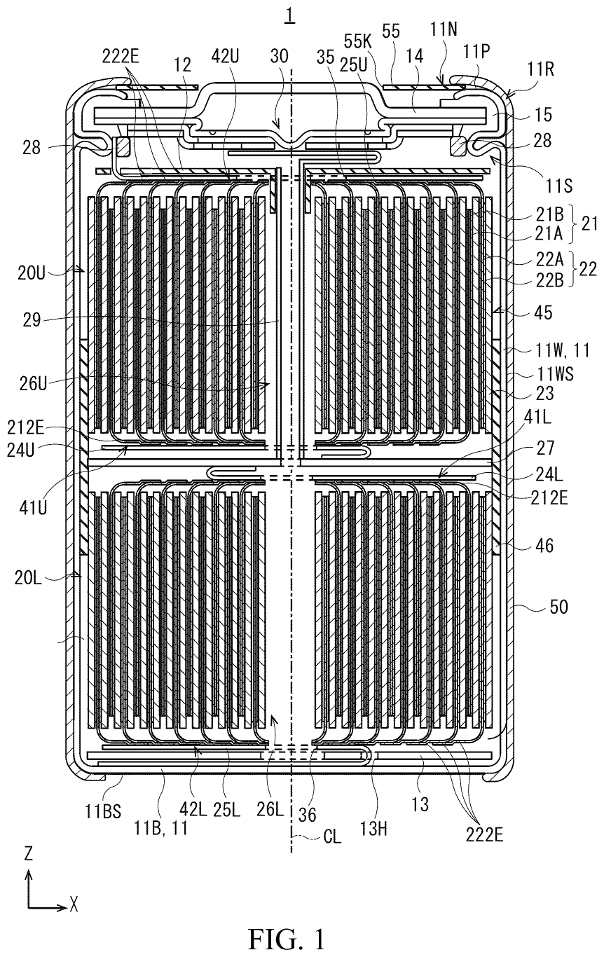

FIG. 1 illustrates a vertical sectional configuration of a lithium-ion secondary battery 1 according to the present an embodiment along a height direction. The lithium-ion secondary battery 1 according to the present an embodiment is hereinafter simply referred to as the “secondary battery 1”. The secondary battery 1 illustrated in FIG. 1 includes an outer package can 11 and a pair of electrode wound bodies 20U and 20L. The outer package can 11 may have a substantially cylindrical shape. The electrode wound body 20U and the electrode wound body 20L may each serve as a battery device contained inside the outer package can 11. The secondary battery 1 may further include an outer package tube 50. The outer package tube 50 may cover an outer peripheral surface of the outer package can 11. Note that, herein, the height direction of the secondary battery 1 corresponds to a Z-axis direction. In the secondary battery 1, the electrode wound body 20U and the electrode wound body 20L may be so disposed inside the outer package can 11 as to be adjacent to each other in the Z-axis direction.

In an embodiment, the secondary battery 1 may include, inside the outer package can 11, a pair of insulating plates 12 and 13, the pair of electrode wound bodies 20U and 20L, a pair of positive electrode current collector plates 24U and 24L, a pair of negative electrode current collector plates 25U and 25L, and a middle positive electrode current collector plate 27. The electrode wound bodies 20U and 20L may each be a structure in which a positive electrode 21 and a negative electrode 22 are stacked on each other with a separator 23 interposed therebetween and are wound, for example. The electrode wound bodies 20U and 20L may each be impregnated with an electrolytic solution. The electrolytic solution may be a liquid electrolyte. In an embodiment, the secondary battery 1 may further include a thermosensitive resistive device, a reinforcing member, or both inside the outer package can 11. Non-limiting examples of the thermosensitive resistive device may include a positive temperature coefficient (PTC) device.

The outer package can 11 may be, as described above, a container that contains the pair of electrode wound bodies 20U and 20L, the pair of positive electrode current collector plates 24U and 24L, the pair of negative electrode current collector plates 25U and 25L, and other components. The outer package can 11 may also serve as a negative electrode terminal coupled to the negative electrode 22 via the pair of negative electrode current collector plates 25U and 25L. In an embodiment, the outer package can 11 may include a bottom part 11B and a sidewall part 11W. The outer package can 11 may have, for example, a hollow cylindrical structure having a lower end part and an upper end part in the Z-axis direction. The lower end part may be closed, and the upper end part may be open. The upper end part of the outer package can 11 may thus be an open end part 11N. The lower end part of the outer package can 11 may be closed by the bottom part 11B having a substantially circular plate shape. The sidewall part 11W may be provided between the open end part 11N and the bottom part 11B. The sidewall part 11W may be provided along an outer edge of the bottom part 11B and may so stand in the height direction as to surround the pair of electrode wound bodies 20U and 20L. The sidewall part 11W may include the open end part 11N on an opposite side to the bottom part 11B. The open end part 11N may be open to allow the pair of electrode wound bodies 20U and 20L to be passed therethrough. The bottom part 11B may be coupled to the negative electrode 22 of the electrode wound body 20L via the negative electrode current collector plate 25L. The sidewall part 11W may be coupled to the negative electrode 22 of the electrode wound body 20U via a coupling member 28 and the negative electrode current collector plate 25U at a portion in the vicinity of the open end part 11N. The outer package can 11 may include, for example, a metal material such as iron. In an embodiment, a surface of the outer package can 11 may be plated with a metal material such as nickel. The insulating plate 12 and the insulating plate 13 may be so opposed to each other as to allow the pair of negative electrode current collector plates 25U and 25L to be interposed therebetween in the Z-axis direction, for example. Note that, herein, the open end part 11N and the vicinity thereof in the Z-axis direction may be referred to as an upper part of the secondary battery 1, and a region where the outer package can 11 is closed and the vicinity thereof in the Z-axis direction may be referred to as a lower part of the secondary battery 1. The outer package can 11 may correspond to a specific but non-limiting example of a “container part” in an embodiment of the present disclosure.

The outer package tube 50 may surround a side surface 11WS that is an outer surface of the sidewall part 11W of the outer package can 11. In an embodiment, the outer package tube 50 may cover a bent part 11P positioned at the upper end part of the outer package can 11, as illustrated in FIG. 1. The bent part 11P will be described later. In an embodiment, the outer package tube 50 may cover a portion of a bottom surface 11BS that is an outer surface of the bottom part 11B of the outer package can 11. The outer package tube 50 may include, for example, a thermally contractible insulating film that includes a material such as a polyester-based resin, a polyamide-based resin, or a thermoplastic elastomer resin.

A washer 55 may be provided in a gap between the outer package tube 50 and the bent part 11P of the outer package can 11. The washer 55 may be an insulating ring member that has an opening 55K in a middle region in a plane orthogonal to the height direction. Disposed in the opening 55K may be a projecting part provided in a middle region of a battery cover 14. The washer 55 may include a material such as black modified polyphenylene ether.

Each of the insulating plates 12 and 13 may be, for example, a circular plate-shaped member including a plate having a surface perpendicular to a central axis CL of the secondary battery 1, that is, a surface perpendicular to a Z-axis in FIG. 1 and having an opening in a middle of the plate. In an embodiment, the insulating plate 12 may further include a cylindrical part that extends toward an inner part of the electrode wound body 20U around the opening of the circular plate-shaped member. One reason for this is to avoid contact of a later-described coupling member 29 with a portion of the negative electrode 22 located around a through hole 26U of the electrode wound body 20U.

For example, a structure in which the battery cover 14 and a safety valve mechanism 30 are crimped with a gasket 15 interposed therebetween, that is, a crimped structure 11R, may be provided at the open end part 11N of the outer package can 11. The outer package can 11 may be sealed by the battery cover 14, with the pair of electrode wound bodies 20U and 20L and other components contained inside the outer package can 11. The crimped structure 11R may include the bent part 11P serving as what is called a crimped part. A narrow part 11S may be provided below the bent part 11P. The narrow part 11S may be a portion of the outer package can 11 that protrudes inward.

The battery cover 14 may be a closing member that closes the open end part 11N in a state where the pair of electrode wound bodies 20U and 20L and other components are contained inside the outer package can 11, for example. The battery cover 14 and the outer package can 11 together may correspond to a specific but non-limiting example of an “outer package body” in an embodiment of the present disclosure. The battery cover 14 and the bottom part 11B of the outer package can 11 are opposed to each other in the Z-axis direction with the pair of electrode wound bodies 20U and 20L interposed therebetween. The battery cover 14 may correspond to a specific but non-limiting example of a “first bottom part” and a “cover part” in an embodiment of the present disclosure. The bottom part 11B of the outer package can 11 may correspond to a specific but non-limiting example of a “second bottom part” in an embodiment of the present disclosure. The sidewall part 11W of the outer package can 11 may correspond to a specific but non-limiting example of a “wall part” in an embodiment of the present disclosure. In an embodiment, the battery cover 14 may be opposed to a later-described second end face 42U of the electrode wound body 20U. In an embodiment, the bottom part 11B of the outer package can 11 may be opposed to a later-described second end face 42L of the electrode wound body 20L. The battery cover 14 may be, for example, an electrical conductor that includes a material similar to the material included in the outer package can 11. In an embodiment, the battery cover 14 may close the open end part 11N of the outer package can 11 and may be coupled to the pair of positive electrode current collector plates 24U and 24L. The battery cover 14 may thus also serve as a positive electrode terminal that is coupled to the positive electrode 21 of the electrode wound body 20U via the positive electrode current collector plate 24U and to the positive electrode 21 of the electrode wound body 20L via the positive electrode current collector plate 24L. The middle region of the battery cover 14 may protrude upward, i.e., in a +Z direction, for example. As a result, a peripheral region, i.e., a region other than the middle region, of the battery cover 14 may be in contact with the safety valve mechanism 30, for example.

The gasket 15 may be a sealing member interposed between the bent part 11P of the outer package can 11 and the battery cover 14, for example. The gasket 15 may seal a gap between the bent part 11P and the battery cover 14. In an embodiment, a surface of the gasket 15 may be coated with a material such as asphalt. The gasket 15 may include any one or more of insulating materials, for example. The insulating material is not particularly limited in kind, and non-limiting examples thereof may include a polymer material such as polybutylene terephthalate (PBT) or polypropylene (PP). In an embodiment, the insulating material may be polybutylene terephthalate. One reason for this is that this helps to allow for sufficient sealing of the gap between the bent part 11P and the battery cover 14, with the outer package can 11 and the battery cover 14 being electrically separated from each other.

The safety valve mechanism 30 may be adapted to cancel the sealed state of the outer package can 11 to thereby release a pressure inside the outer package can 11, i.e., an internal pressure of the outer package can 11, on an as-needed basis upon an increase in the internal pressure of the outer package can 11, for example. Non-limiting examples of a cause of the increase in the internal pressure of the outer package can 11 may include a gas generated due to a decomposition reaction of the electrolytic solution upon charging and discharging. The internal pressure of the outer package can 11 can also increase due to heating from outside.

The electrode wound body 20U and the electrode wound body 20L may be disposed to be adjacent to each other in the Z-axis direction, i.e., the height direction of the secondary battery 1. For example, the electrode wound body 20U may be positioned at the upper part of the secondary battery 1, and the electrode wound body 20L may be positioned at the lower part of the secondary battery 1. The electrode wound body 20U includes a first end face 41U and the second end face 42U on respective ends of a later-described stacked body S20 in the width direction, i.e., on respective ends of the stacked body S20 in the Z-axis direction. The positive electrode 21 is exposed on the first end face 41U. The negative electrode 22 is exposed on the second end face 42U. The electrode wound body 20L includes a first end face 41L and the second end face 42L on respective ends of a stacked body S20 in the width direction, i.e., on respective ends of the stacked body S20 in the Z-axis direction. The positive electrode 21 is exposed on the first end face 41L. The negative electrode 22 is exposed on the second end face 42L. In the configuration example illustrated in FIG. 1, the electrode wound body 20U and the electrode wound body 20L are so disposed adjacent to each other in the Z-axis direction that the first end face 41U and the first end face 41L are opposed to each other. For example, in the configuration example illustrated in FIG. 1, the second end face 42U of the electrode wound body 20U may be opposed to the insulating plate 12 with the negative electrode current collector plate 25U interposed therebetween, and the second end face 42L of the electrode wound body 20L may be opposed to the insulating plate 13 with the negative electrode current collector plate 25L interposed therebetween. The positive electrode current collector plates 24U and 24L and the middle positive electrode current collector plate 27 may be disposed between the first end face 41U and the first end face 41L. The middle positive electrode current collector plate 27 may be interposed between the positive electrode current collector plate 24U and the positive electrode current collector plate 24L in the Z-axis direction. The middle positive electrode current collector plate 27 may be an electrically conductive member having a circular plate shape. The middle positive electrode current collector plate 27 may have an opening at a position corresponding to a position of, for example, each of the through hole 26U and a through hole 26L. The electrode wound bodies 20U and 20L may each be a power generation device that causes charging and discharging reactions to proceed. The electrode wound bodies 20U and 20L may each include the positive electrode 21, the negative electrode 22, the separator 23, and the electrolytic solution, i.e., a liquid electrolyte. Herein, the through hole 26U and the through hole 26L may each be generically referred to as the through hole 26, without being distinguished from each other. Herein, the electrode wound body 20U and the electrode wound body 20L may each be generically referred to as the electrode wound body 20, without being distinguished from each other.

The electrode wound body 20U may correspond to a specific but non-limiting example of a “first electrode wound body” in an embodiment of the present disclosure. The electrode wound body 20L may correspond to a specific but non-limiting example of a “second electrode wound body” in an embodiment of the present disclosure. The positive electrode current collector plate 24U may correspond to a specific but non-limiting example of a “primary first electrode current collector plate” in an embodiment of the present disclosure. The positive electrode current collector plate 24L may correspond to a specific but non-limiting example of a “secondary first electrode current collector plate” in an embodiment of the present disclosure. The negative electrode current collector plate 25U may correspond to a specific but non-limiting example of a “primary second electrode current collector plate” in an embodiment of the present disclosure. The negative electrode current collector plate 25L may correspond to a specific but non-limiting example of a “secondary second electrode current collector plate” in an embodiment of the present disclosure.

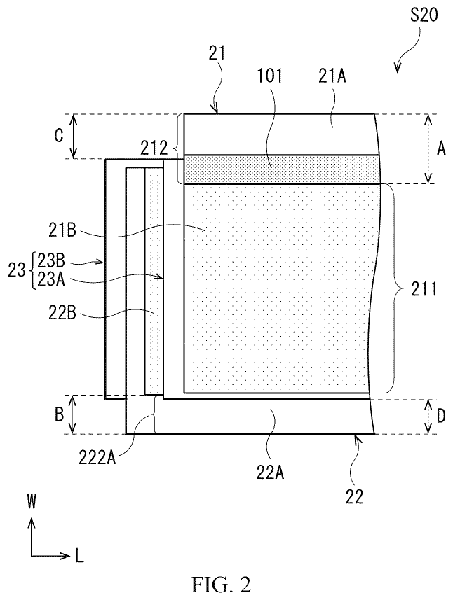

The electrode wound bodies 20U and 20L may each include the stacked body S20. The stacked body S20 included in each of the electrode wound bodies 20U and 20L may have substantially the same structure. FIG. 2 is a developed view of the stacked body S20, and schematically illustrates a portion of the stacked body S20. As illustrated in FIG. 2, the stacked body S20 includes the positive electrode 21, the negative electrode 22, and the separator 23. In the stacked body S20, the positive electrode 21 and the negative electrode 22 may be stacked on each other with the separator 23 interposed therebetween. The separator 23 may include, for example, two bases, i.e., a first separator member 23A and a second separator member 23B. The stacked body S20 may thus have a four-layered structure in which the positive electrode 21, the first separator member 23A, the negative electrode 22, and the second separator member 23B are stacked in order. Each of the positive electrode 21, the first separator member 23A, the negative electrode 22, and the second separator member 23B may be a substantially band-shaped member in which a W direction corresponds to a transverse direction and an L direction corresponds to a longitudinal direction. The positive electrode 21 may correspond to a specific but non-limiting example of a “first electrode” in an embodiment of the present disclosure. The negative electrode 22 may correspond to a specific but non-limiting example of a “second electrode” in an embodiment of the present disclosure.

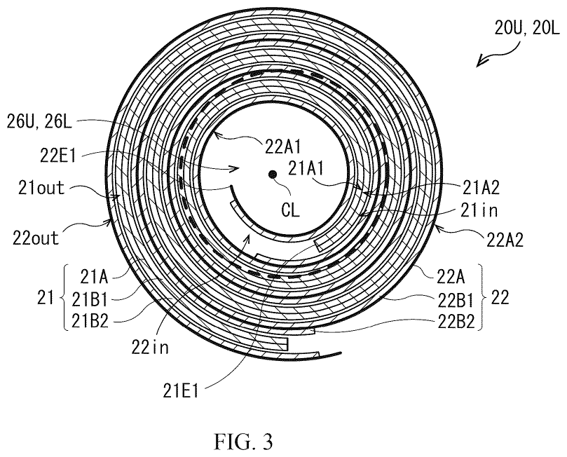

As illustrated in FIG. 3, the electrode wound bodies 20U and 20L may each be the stacked body S20 so wound around the through hole 26 that extends along the central axis CL extending in the Z-axis direction as to form a spiral shape in a horizontal section orthogonal to the Z-axis direction. Here, the stacked body S20 may be wound in an orientation in which the W direction substantially coincides with the Z-axis direction. Note that FIG. 3 illustrates a configuration example of each of the electrode wound bodies 20U and 20L, along the horizontal section orthogonal to the Z-axis direction. Note that, for higher visibility, FIG. 3 omits illustration of the separator 23. Each of the electrode wound bodies 20U and 20L may have an outer appearance of a substantially circular columnar shape as a whole. The positive electrode 21 and the negative electrode 22 may be wound, remaining in a state of being opposed to each other with the separator 23 interposed therebetween. The electrode wound bodies 20U and 20L may each have the through hole 26 as an internal space at a center thereof. The through hole 26 may be a hole into which a winding core for assembling the electrode wound body 20 and an electrode rod for welding are each to be put. The through hole 26 may extend in the Z-axis direction along the central axis CL, and is provided through the electrode wound body 20. The stacked body S20 may thus be wound around the through hole 26. Note that, in FIG. 1, a reference sign 26U denotes the through hole 26 of the electrode wound body 20U, and a reference sign 26L denotes the through hole 26 of the electrode wound body 20L. As illustrated in FIG. 1, in an embodiment, the electrode wound body 20U and the electrode wound body 20L may be so disposed that the through hole 26U and the through hole 26L communicate each other in the Z-axis direction.

The positive electrode 21, the negative electrode 22, and the separator 23 may be so wound that the separator 23 is positioned in each of an outermost wind of the electrode wound body 20 and an innermost wind of the electrode wound body 20. In the outermost wind of the electrode wound body 20, the negative electrode 22 may be positioned on an outer side relative to the positive electrode 21. For example, as illustrated in FIG. 3, an outermost wind part 21out of the positive electrode 21 positioned in an outermost wind of the positive electrode 21 included in each of the electrode wound bodies 20U and 20L may be positioned on an inner side relative to an outermost wind part 22out of the negative electrode 22 positioned in an outermost wind of the negative electrode 22 included in corresponding one of the electrode wound bodies 20U and 20L. Here, the outermost wind part 21out of the positive electrode 21 may be a part corresponding to the outermost one wind of the positive electrode 21 in each of the electrode wound bodies 20U and 20L. The outermost wind part 22out of the negative electrode 22 may be a part corresponding to the outermost one wind of the negative electrode 22 in each of the electrode wound bodies 20U and 20L. In contrast, in the innermost wind of each of the electrode wound bodies 20U and 20L, the negative electrode 22 may be positioned on the inner side relative to the positive electrode 21. For example, as illustrated in FIG. 3, an innermost wind part 22in of the negative electrode 22 positioned in an innermost wind of the negative electrode 22 included in each of the electrode wound bodies 20U and 20L may be positioned on the inner side relative to an innermost wind part 21in of the positive electrode 21 positioned in an innermost wind of the positive electrode 21 included in corresponding one of the electrode wound bodies 20U and 20L. Here, the innermost wind part 21in of the positive electrode 21 may be a part corresponding to the innermost one wind of the positive electrode 21 in each of the electrode wound bodies 20U and 20L. The innermost wind part 22in of the negative electrode 22 may be a part corresponding to the innermost one wind of the negative electrode 22 in each of the electrode wound bodies 20U and 20L. The number of winds of each of the positive electrode 21, the negative electrode 22, and the separator 23 is not particularly limited, and may be chosen as desired.

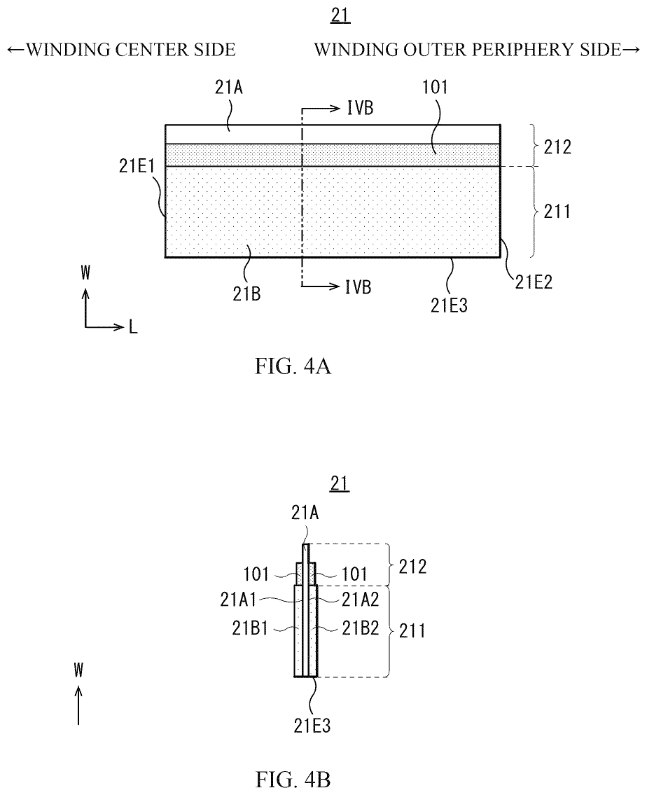

FIG. 4A is a developed view of the positive electrode 21, and schematically illustrates a state before being wound. FIG. 4B illustrates a sectional configuration of the positive electrode 21. Note that FIG. 4B illustrates a section as viewed in an arrowed direction along line IVB-IVB illustrated in FIG. 4A. In an embodiment, the positive electrode 21 may include, for example, a positive electrode current collector 21A and a positive electrode active material layer 21B. In an embodiment, the positive electrode active material layer 21B may be provided simply on one of two opposite surfaces of the positive electrode current collector 21A. In an embodiment, the positive electrode active material layer 21B may be provided on each of the two opposite surfaces of the positive electrode current collector 21A. FIG. 4B illustrates an example case where the positive electrode active material layer 21B is provided on each of the two opposite surfaces of the positive electrode current collector 21A. For example, the positive electrode current collector 21A may include an inward surface 21A1 and an outward surface 21A2. The inward surface 21A1 may face toward a winding center side of the electrode wound body 20, i.e., toward the central axis CL. The outward surface 21A2 may face toward an opposite side to the winding center side of the electrode wound body 20. In other words, the outward surface 21A2 may be positioned on an opposite side of the positive electrode current collector 21A to the inward surface 21A1. The positive electrode 21 may include an inner winding side positive electrode active material layer 21B1 and an outer winding side positive electrode active material layer 21B2, as the positive electrode active material layers 21B. The inner winding side positive electrode active material layer 21B1 may cover all or a part of the inward surface 21A1 of the positive electrode current collector 21A. The outer winding side positive electrode active material layer 21B2 may cover all or a part of the outward surface 21A2 of the positive electrode current collector 21A. Herein, the inner winding side positive electrode active material layer 21B1 and the outer winding side positive electrode active material layer 21B2 may each be generically referred to as the positive electrode active material layer 21B, without being distinguished from each other. In an embodiment, the positive electrode active material layer 21B may extend in both the L direction and the W direction orthogonal to the L direction. The L direction corresponds to a longitudinal direction of the positive electrode 21. The W direction corresponds to a width direction of the positive electrode 21. The L direction corresponds to a winding direction of the stacked body S20. The W direction substantially coincides with the central axis CL. The positive electrode current collector 21A may correspond to a specific but non-limiting example of a “first electrode current collector” in an embodiment of the present disclosure. The positive electrode active material layer 21B may correspond to a specific but non-limiting example of a “first electrode active material layer” in an embodiment of the present disclosure.

In an embodiment, the positive electrode current collector 21A may include a positive electrode covered region 211 and a positive electrode exposed region 212. The positive electrode covered region 211 may be covered with the positive electrode active material layer 21B. The positive electrode exposed region 212 may be covered with no positive electrode active material layer 21B and extend in the W direction. As illustrated in FIG. 4A, the positive electrode covered region 211 and the positive electrode exposed region 212 may each extend along the L direction, i.e., the longitudinal direction of the positive electrode 21, from a winding center side edge 21E1 of the positive electrode 21, i.e., an edge of the positive electrode 21 on the winding center side in the L direction, to a winding outer periphery side edge 21E2 of the positive electrode 21, i.e., an edge of the positive electrode 21 on a winding outer periphery side in the L direction. Here, the L direction corresponds to a winding direction of each of the electrode wound bodies 20U and 20L. In other words, in the positive electrode 21, the positive electrode current collector 21A may be covered with the positive electrode active material layer 21B from the winding center side edge 21E1 of the positive electrode 21 to the winding outer periphery side edge 21E2 of the positive electrode 21 in the winding direction of each of the electrode wound bodies 20U and 20L. The positive electrode covered region 211 and the positive electrode exposed region 212 may be adjacent to each other in the W direction, i.e., the transverse direction of the positive electrode 21. The W direction substantially coincides with the central axis CL. As illustrated in FIG. 3, in each of the electrode wound bodies 20U and 20L, the winding center side edge 21E1 at the innermost wind part 21in of the positive electrode 21 may be located at a position retracted from a winding center side edge 22E1 of the negative electrode 22, i.e., an edge of the negative electrode 22 on the winding center side in the L direction, at the innermost wind part 22in of the negative electrode 22. The positive electrode 21 may further have a lower edge 21E3 that extends in the L direction on a lower side of the electrode wound body 20. Note that FIGS. 4A and 4B each schematically illustrate the positive electrode current collector 21A in a straightened state along the W direction. In actuality, however, as illustrated in FIG. 1, a positive electrode edge part 212E of the positive electrode exposed region 212 may be bent toward the central axis CL and may be coupled to corresponding one of the positive electrode current collector plates 24U and 24L. In an embodiment, an end part of the positive electrode exposed region 212 in the W direction may form corresponding one of the first end faces 41U and 41L and may be coupled to the corresponding one of the positive electrode current collector plates 24U and 24L, as illustrated in FIG. 1. In an embodiment, the first end faces 41U and 41L may each include the positive electrode edge part 212E, of the positive electrode exposed region 212, that is bent toward the corresponding one of the through holes 26U and 26L with the corresponding one of the electrode wound bodies 20U and 20L being wound.

In an embodiment, an insulating layer 101 may be provided in a region including a border between the positive electrode covered region 211 and the positive electrode exposed region 212 and the vicinity of the border. As with the positive electrode covered region 211 and the positive electrode exposed region 212, in an embodiment, the insulating layer 101 may also extend from the winding center side edge 21E1 to the winding outer periphery side edge 21E2 of the positive electrode 21. In an embodiment, the insulating layer 101 may be adhered to the first separator member 23A, the second separator member 23B, or both. One reason for this is that this helps to prevent the positive electrode 21 and the separator 23 from becoming misaligned with each other. In an embodiment, the insulating layer 101 may include a resin including polyvinylidene difluoride (PVDF). One reason for this is that when the insulating layer 101 includes PVDF, the insulating layer 101 is swollen by, for example, a solvent included in the electrolytic solution, which helps to allow the insulating layer 101 to be favorably adhered to the separator 23. An example detailed configuration of the positive electrode 21 will be described later. The positive electrode covered region 211 may correspond to a specific but non-limiting example of a “first electrode covered region” in an embodiment of the present disclosure. The positive electrode exposed region 212 may correspond to a specific but non-limiting example of a “first electrode exposed region” in an embodiment of the present disclosure.

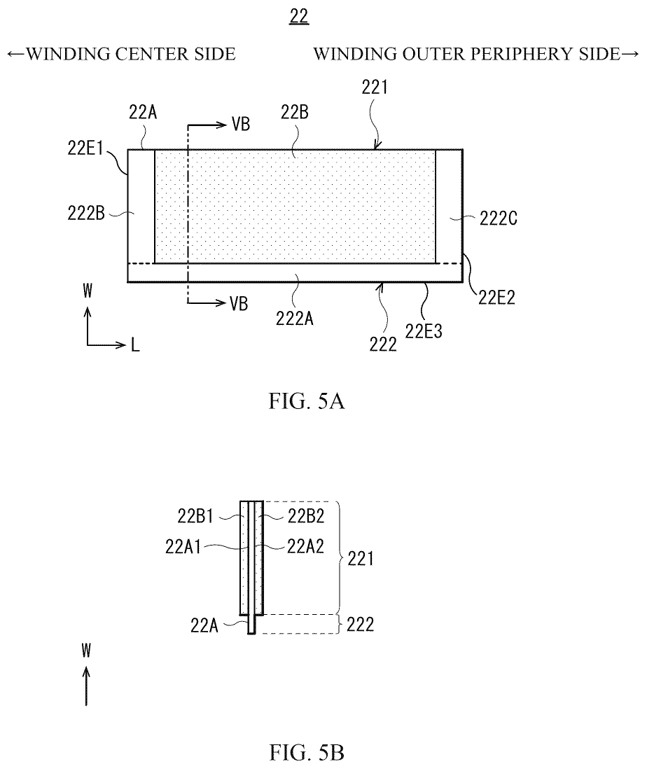

FIG. 5A is a developed view of the negative electrode 22, and schematically illustrates a state before being wound. FIG. 5B illustrates a sectional configuration of the negative electrode 22. Note that FIG. 5B illustrates a section as viewed in an arrowed direction along line VB-VB illustrated in FIG. 5A. In an embodiment, the negative electrode 22 may include, for example, a negative electrode current collector 22A and a negative electrode active material layer 22B. The negative electrode active material layer 22B may cover a portion of the negative electrode current collector 22A. In an embodiment, the negative electrode active material layer 22B may be provided simply on one of two opposite surfaces of the negative electrode current collector 22A. In an embodiment, the negative electrode active material layer 22B may be provided on each of the two opposite surfaces of the negative electrode current collector 22A. FIG. 5B illustrates an example case where the negative electrode active material layer 22B is provided on each of the two opposite surfaces of the negative electrode current collector 22A. For example, the negative electrode current collector 22A may include an inward surface 22A1 and an outward surface 22A2. The inward surface 22A1 may face toward a winding center side of the electrode wound body 20, i.e., toward the central axis CL. The outward surface 22A2 may face toward an opposite side to the winding center side of the electrode wound body 20. In other words, the outward surface 22A2 may be positioned on an opposite side of the negative electrode current collector 22A to the inward surface 22A1. The negative electrode 22 may include an inner winding side negative electrode active material layer 22B1 and an outer winding side negative electrode active material layer 22B2, as the negative electrode active material layers 22B. The inner winding side negative electrode active material layer 22B1 may cover all or a part of the inward surface 22A1 of the negative electrode current collector 22A. The outer winding side negative electrode active material layer 22B2 may cover all or a part of the outward surface 22A2 of the negative electrode current collector 22A. Herein, the inner winding side negative electrode active material layer 22B1 and the outer winding side negative electrode active material layer 22B2 may each be generically referred to as the negative electrode active material layer 22B, without being distinguished from each other. The negative electrode current collector 22A may correspond to a specific but non-limiting example of a “second electrode current collector” in an embodiment of the present disclosure. The negative electrode active material layer 22B may correspond to a specific but non-limiting example of a “second electrode active material layer” in an embodiment of the present disclosure.

In an embodiment, the negative electrode 22 may include a negative electrode covered region 221 and a negative electrode exposed region 222. The negative electrode covered region 221 may be a region in which the negative electrode current collector 22A is covered with the negative electrode active material layer 22B. The negative electrode exposed region 222 may be a region in which the negative electrode current collector 22A is not covered with the negative electrode active material layer 22B and is exposed. As illustrated in FIG. 5A, the negative electrode covered region 221 and the negative electrode exposed region 222 may each extend along the L direction, i.e., the longitudinal direction of the negative electrode 22. The negative electrode exposed region 222 may extend from the winding center side edge 22E1 of the negative electrode 22 to a winding outer periphery side edge 22E2 of the negative electrode 22, i.e., an edge of the negative electrode 22 on the winding outer periphery side in the L direction, in the winding direction of each of the electrode wound bodies 20U and 20L. In contrast, the negative electrode covered region 221 may be provided at neither the winding center side edge 22E1 nor the winding outer periphery side edge 22E2 of the negative electrode 22. As illustrated in FIG. 5A, portions of the negative electrode exposed region 222 may be so provided as to allow the negative electrode covered region 221 to be interposed therebetween in the L direction, i.e., the longitudinal direction of the negative electrode 22. For example, the negative electrode exposed region 222 may include a first part 222A, a second part 222B, and a third part 222C. The negative electrode 22 may further have a lower edge 22E3 that extends in the L direction on a lower side of the electrode wound body 20. The first part 222A may be adjacent to the negative electrode covered region 221 in the W direction and may extend from the winding center side edge 22E1 of the negative electrode 22 to the winding outer periphery side edge 22E2 of the negative electrode 22 in the L direction. The second part 222B and the third part 222C may be so provided as to allow the negative electrode covered region 221 to be interposed therebetween in the L direction. The first part 222A may be positioned in a region including the lower edge 22E3 and the vicinity thereof in the negative electrode 22. For example, the second part 222B may be positioned in a region including the winding center side edge 22E1 and the vicinity thereof in the negative electrode 22, and the third part 222C may be positioned in a region including the winding outer periphery side edge 22E2 and the vicinity thereof in the negative electrode 22. Note that FIGS. 5A and 5B each schematically illustrate the negative electrode current collector 22A in the straightened state along the W direction. In actuality, however, as illustrated in FIG. 1, in each of the electrode wound bodies 20U and 20L, a negative electrode edge part 222E of the negative electrode exposed region 222 may be bent toward the central axis CL and may be coupled to corresponding one of the negative electrode current collector plates 25U and 25L. In an embodiment, an end part of the negative electrode exposed region 222 in the W direction may form corresponding one of the second end faces 42U and 42L and may be coupled to corresponding one of the negative electrode current collector plates 25U and 25L, as illustrated in FIG. 1. In an embodiment, the second end faces 42U and 42L may each include the negative electrode edge part 222E, of the negative electrode exposed region 222, that is bent toward the through hole 26 with the corresponding one of the electrode wound bodies 20U and 20L being wound. An example detailed configuration of the negative electrode 22 will be described later. The negative electrode covered region 221 may correspond to a specific but non-limiting example of a “second electrode covered region” in an embodiment of the present disclosure. The negative electrode exposed region 222 may correspond to a specific but non-limiting example of a “second electrode exposed region” in an embodiment of the present disclosure.

In the stacked body S20, the positive electrode 21 and the negative electrode 22 may be so stacked on each other with the separator 23 interposed therebetween that the positive electrode exposed region 212 and the first part 222A of the negative electrode exposed region 222 are on opposite sides to each other along the W direction, i.e., the width direction. In each of the electrode wound bodies 20U and 20L, an end part of the separator 23 may be fixed by attaching a fixing tape 46 having an insulating property to a side surface part 45 of corresponding one of the electrode wound bodies 20U and 20L to thereby prevent loosening of winding. In an embodiment, the fixing tape 46 may be so provided as to also cover a gap between the electrode wound body 20U and the electrode wound body 20L positioned adjacent to each other in the Z-axis direction. One reason for this is to prevent the positive electrode current collector plates 24U and 24L and the middle positive electrode current collector plate 27 that are provided in the gap between the electrode wound body 20U and the electrode wound body 20L from coming into contact with an inner surface of the sidewall part 11W of the outer package can 11 that serves as the negative electrode terminal, thus preventing an occurrence of an internal short circuit.

In an embodiment, as illustrated in FIG. 2, the secondary battery 1 may satisfy A>B, where A is a width of the positive electrode exposed region 212, and B is a width of the first part 222A of the negative electrode exposed region 222. For example, when the width A is 7 (mm), the width B may be 4 (mm). In an embodiment, the secondary battery 1 may satisfy C>D, where C is a width of a portion of the positive electrode exposed region 212 protruding from an outer edge in the width direction of the separator 23, and D is a width of a portion of the first part 222A of the negative electrode exposed region 222 protruding from an opposite outer edge in the width direction of the separator 23. For example, when the width C is 4.5 (mm), the width D may be 3 (mm).

As illustrated in FIG. 1, in each of the electrode wound bodies 20U and 20L, multiple portions of the positive electrode edge part 212E, of the positive electrode exposed region 212 wound around the central axis CL, that are adjacent to each other in a radial direction, i.e., an R direction, of the electrode wound body 20 (i.e., corresponding one of the electrode wound bodies 20U and 20L) may be so bent toward the central axis CL as to overlap each other. The portions of the positive electrode edge part 212E may thus form each of the first end faces 41U and 41L. Similarly, in each of the electrode wound bodies 20U and 20L, multiple portions of the negative electrode edge part 222E, of the negative electrode exposed region 222 wound around the central axis CL, that are adjacent to each other in a radial direction, i.e., an R direction, of the electrode wound body 20 (i.e., corresponding one of the electrode wound bodies 20U and 20L) may be so bent toward the central axis CL as to overlap each other. The portions of the negative electrode edge part 222E may thus form corresponding one of the second end faces 42U and 42L.

Accordingly, the portions of the positive electrode edge part 212E of the positive electrode exposed region 212 may gather at corresponding one of the first end faces 41U and 41L, and the portions of the negative electrode edge part 222E of the negative electrode exposed region 222 may gather at corresponding one of the second end faces 42U and 42L. In an embodiment, to achieve better contact between each of the positive electrode current collector plates 24U and 24L for extracting a current and the positive electrode edge part 212E, the portions of the positive electrode edge part 212E bent toward the central axis CL may form a flat surface. Similarly, in an embodiment, to achieve better contact between each of the negative electrode current collector plates 25U and 25L for extracting a current and the negative electrode edge part 222E, the portions of the negative electrode edge part 222E bent toward the central axis CL may form a flat surface. Note that as used herein, the term “flat surface” may encompass not only a completely flat surface but also a surface having some asperities or surface roughness to the extent that joining of the positive electrode exposed region 212 to corresponding one of the positive electrode current collector plates 24U and 24L and joining of the negative electrode exposed region 222 to corresponding one of the negative electrode current collector plates 25U and 25L are possible.

The positive electrode current collector 21A may include an electrically conductive foil such as an aluminum foil, as will be described later. The negative electrode current collector 22A may include an electrically conductive foil such as a copper foil, as will be described later. In this case, the positive electrode current collector 21A may be softer than the negative electrode current collector 22A. For example, the positive electrode exposed region 212 may have a Young's modulus lower than a Young's modulus of the negative electrode exposed region 222. Accordingly, in an embodiment, the secondary battery 1 may satisfy both A>B and C>D regarding the widths A to D. In such a case, when the positive electrode exposed region 212 and the negative electrode exposed region 222 are substantially simultaneously bent with substantially equal pressures from both electrode sides, the bent portion in the positive electrode 21 and the bent portion in the negative electrode 22 may sometimes become substantially equal in height measured from respective ends of the separator 23. In this case, the portions of the positive electrode edge part 212E of the positive electrode exposed region 212 illustrated in FIG. 1 may appropriately overlap each other by being bent. This helps to allow for easy joining of the positive electrode exposed region 212 and each of the positive electrode current collector plates 24U and 24L. Similarly, the portions of the negative electrode edge part 222E of the negative electrode exposed region 222 illustrated in FIG. 1 may appropriately overlap each other by being bent. This helps to allow for easy joining of the negative electrode exposed region 222 and each of the negative electrode current collector plates 25U and 25L. As used herein, the term “joining” may refer to coupling by, for example, laser welding; however, a method of joining is not limited to laser welding. In an embodiment, any other coupling method may be used.

As illustrated in FIG. 2, a portion, of the positive electrode exposed region 212 of the positive electrode 21, that is opposed to the negative electrode 22 with the separator 23 interposed therebetween may be covered with the insulating layer 101. The insulating layer 101 may have a width of 3 mm in the W direction, for example. The insulating layer 101 may entirely cover a portion, of the positive electrode exposed region 212 of the positive electrode 21, that is opposed to the negative electrode covered region 221 of the negative electrode 22 with the separator 23 interposed therebetween. The insulating layer 101 helps to effectively prevent an internal short circuit of the secondary battery 1 when foreign matter enters between the negative electrode covered region 221 and the positive electrode exposed region 212, for example. Further, when the secondary battery 1 undergoes an impact, the insulating layer 101 absorbs the impact, thereby helping to effectively prevent, for example, bending of the positive electrode exposed region 212 or a short circuit between the positive electrode exposed region 212 and the negative electrode 22.

In an existing lithium-ion secondary battery, for example, a lead for current extraction is welded to one location on each of a positive electrode and a negative electrode. However, such a structure increases the internal resistance of the lithium-ion secondary battery, causing the lithium-ion secondary battery to generate heat and become hot upon discharging; therefore, the structure is unsuitable for discharging at a high rate. In an embodiment, the positive electrode current collector plate 24U may be disposed to face the first end face 41U, and the positive electrode current collector plate 24L may be disposed to face the first end face 41L. The negative electrode current collector plate 25U may be disposed to face the second end face 42U, and the negative electrode current collector plate 25L may be disposed to face the second end face 42L. In addition, the positive electrode covered region 211 that forms the first end face 41U and the positive electrode current collector plate 24U may be welded to each other at multiple points; the positive electrode covered region 211 that forms the first end face 41L and the positive electrode current collector plate 24L may be welded to each other at multiple points; the negative electrode covered region 221 that forms the second end face 42U and the negative electrode current collector plate 25U may be welded to each other at multiple points; and the negative electrode covered region 221 that forms the second end face 42L and the negative electrode current collector plate 25L may be welded to each other at multiple points. This helps to allow for a reduced internal resistance of the secondary battery 1. Each of the first end faces 41U and 41L and each of the second end faces 42U and 42L being a flat surface as described above also contributes to the reduced resistance. Each of the positive electrode current collector plates 24U and 24L may be coupled to the middle positive electrode current collector plate 27. The middle positive electrode current collector plate 27 may be electrically coupled to the battery cover 14 via the coupling member 29 and the safety valve mechanism 30, for example. In an embodiment, the positive electrode current collector plates 24U and 24L may thus be electrically continuous with the battery cover 14. In an embodiment, the coupling member 29 may be a cylindrical member with a height direction of the cylindrical member extending in the width direction, i.e., the W direction, of the stacked body S20. In an embodiment, the coupling member 29 may be a partially cylindrical member having a slit at a portion of the cylindrical member with the height direction of the cylindrical member extending in the width direction, i.e., the W direction, of the stacked body S20. The coupling member 29 may include a material that is the same as or similar to the material included in the positive electrode current collector plate 24U. The material included in the positive electrode current collector plate 24U will be described later. The coupling member 29 may correspond to a specific but non-limiting example of a “first coupling member” in an embodiment of the present disclosure.

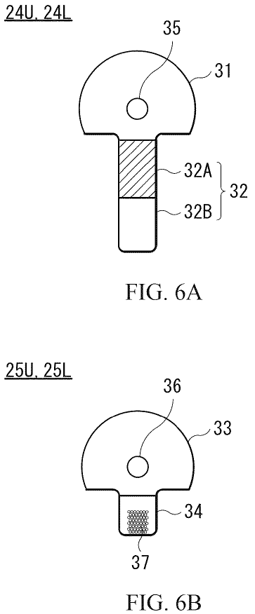

FIG. 6A is a developed diagram illustrating a configuration example of each of the positive electrode current collector plates 24U and 24L. Each of the positive electrode current collector plates 24U and 24L may be a metal plate including, for example but not limited to, aluminum or an aluminum alloy as a single component, or a composite material of aluminum and the aluminum alloy. As illustrated in FIG. 6A, each of the positive electrode current collector plates 24U and 24L may include a fan-shaped part 31 and a band-shaped part 32. The fan-shaped part 31 may have a substantially fan shape. The band-shaped part 32 may have a substantially rectangular shape. A shape of each of the positive electrode current collector plates 24U and 24L is, however, not limited to the shape illustrated in FIG. 6A, and may be chosen as desired. Note that in the secondary battery 1, each of the positive electrode current collector plates 24U and 24L may be contained inside the outer package can 11, as illustrated in FIG. 1, in a state where the band-shaped part 32 is bent with respect to the fan-shaped part 31. FIG. 6A illustrates each of the positive electrode current collector plates 24U and 24L in an unbent state. The fan-shaped part 31 may be a facing part facing and coupled to corresponding one of the first end faces 41U and 41L. The fan-shaped part 31 may have an outer edge including a linear part and a curved part, for example. The fan-shaped part 31 may have an opening 35 in the vicinity of a middle thereof. FIG. 6A illustrates an example case where the opening 35 has a circular plan shape in a horizontal plane orthogonal to the Z-axis direction. The band-shaped part 32 may be coupled to the linear part of the outer edge of the fan-shaped part 31, for example. The band-shaped part 32 may extend in a direction intersecting with the linear part of the fan-shaped part 31. In the secondary battery 1, each of the positive electrode current collector plates 24U and 24L may be so provided as to allow the opening 35 to overlap corresponding one of the through holes 26U and 26L in the Z-axis direction. A hatched portion in FIG. 6A represents an insulating part 32A of the band-shaped part 32. The insulating part 32A may be a portion of the band-shaped part 32 and may have an insulating tape attached thereto or an insulating material applied thereto. Of the band-shaped part 32, a portion below the insulating part 32A may be a coupling part 32B to be coupled to a sealing plate that also serves as an external terminal. The sealing plate may be electrically continuous with the battery cover 14. Note that when the secondary battery 1 has a battery structure without a metallic center pin in the through hole 26 as illustrated in FIG. 1, there is a low possibility that the band-shaped part 32 will come into contact with a region of a negative electrode potential. In an embodiment, each of the positive electrode current collector plates 24U and 24L does not have to include the insulating part 32A. When each of the positive electrode current collector plates 24U and 24L does not include the insulating part 32A, a charge and discharge capacity is allowed to be increased by increasing a width of each of the positive electrode 21 and the negative electrode 22 by an amount corresponding to a thickness of the insulating part 32A.

In an embodiment, the negative electrode current collector plate 25U may be provided between the battery cover 14 and the second end face 42U of the electrode wound body 20U. In an embodiment, the negative electrode current collector plate 25L may be provided between the bottom part 11B and the second end face 42L of the electrode wound body 20L. Each of the negative electrode current collector plates 25U and 25L may be electrically coupled to the outer package can 11, for example. FIG. 6B is a developed diagram illustrating a configuration example of each of the negative electrode current collector plates 25U and 25L. Each of the negative electrode current collector plates 25U and 25L may be a metal plate including, for example but not limited to, nickel, a nickel alloy, copper, or a copper alloy as a single component, or a composite material of two or more thereof. Each of the negative electrode current collector plates 25U and 25L illustrated in FIG. 6B may have a shape similar to the shape of each of the positive electrode current collector plates 24U and 24L illustrated in FIG. 6A. Each of the negative electrode current collector plates 25U and 25L may include a fan-shaped part 33 and a band-shaped part 34. The fan-shaped part 33 may have a substantially fan shape. The band-shaped part 34 may have a substantially rectangular shape. The shape of each of the negative electrode current collector plates 25U and 25L is, however, not limited to the shape illustrated in FIG. 6B, and may be chosen as desired. The band-shaped part 34 may have a width W34 within a range from approximately 3.0 mm to 8.0 mm both inclusive. Note that in the secondary battery 1, each of the negative electrode current collector plates 25U and 25L may be contained inside the outer package can 11, as illustrated in FIG. 1, in a state where the band-shaped part 34 is bent with respect to the fan-shaped part 33. FIG. 6B illustrates each of the negative electrode current collector plates 25U and 25L in an unbent state. The fan-shaped part 33 may be a facing part facing and coupled to corresponding one of the second end faces 42U and 42L. The fan-shaped part 33 may have an outer edge including a linear part and a curved part, for example. The band-shaped part 34 may be coupled to a portion of the outer edge of the fan-shaped part 33. The band-shaped part 34 may extend in a direction intersecting with the linear part of the fan-shaped part 33. The band-shaped part 34 may be shorter than the band-shaped part 32, and may include no portion corresponding to the insulating part 32A of each of the positive electrode current collector plates 24U and 24L. The band-shaped part 34 may be provided with projections 37 that are depicted as circles. The projections 37 may each be of a round shape. All or a part of the projections 37 provided on the band-shaped part 34 of the negative electrode current collector plate 25L may be welded to the bottom part 11B of the outer package can 11. Upon resistance welding, a current may be concentrated on the projections 37, causing the projections 37 to melt to cause the band-shaped part 34 to be welded to the bottom part 11B of the outer package can 11. The band-shaped part 34 of the negative electrode current collector plate 25U may be electrically coupled to the outer package can 11 via the coupling member 28. The coupling member 28 may be an annular member provided to circle around the central axis CL and may include an electrically conductive material similar to a material included in the negative electrode current collector plate 25U, for example. The coupling member 28 may be coupled to an inner surface of the narrow part 11S of the outer package can 11, for example. As with each of the positive electrode current collector plates 24U and 24L, each of the negative electrode current collector plates 25U and 25L may have an opening 36 in the vicinity of a middle of the fan-shaped part 33. In the secondary battery 1, each of the negative electrode current collector plates 25U and 25L may be so provided as to allow the opening 36 to overlap the through hole 26 in the Z-axis direction. FIG. 6B illustrates an example case where the opening 36 has a circular plan shape in a horizontal plane orthogonal to the Z-axis direction. The coupling member 28 may correspond to a specific but non-limiting example of a “second coupling member” in an embodiment of the present disclosure.

The fan-shaped part 31 of the positive electrode current collector plate 24U may simply cover a portion of the first end face 41U, owing to a plan shape of the fan-shaped part 31. The fan-shaped part 31 of the positive electrode current collector plate 24L may simply cover a portion of the first end face 41L, owing to a plan shape of the fan-shaped part 31. Similarly, the fan-shaped part 33 of the negative electrode current collector plate 25U may simply cover a portion of the second end face 42U, owing to a plan shape of the fan-shaped part 33. The fan-shaped part 33 of the negative electrode current collector plate 25L may simply cover a portion of the second end face 42L, owing to a plan shape of the fan-shaped part 33. Reasons why the respective fan-shaped parts 31 do not cover the entire first end faces 41U and 41L, and the respective fan-shaped parts 33 do not cover the entire second end faces 42U and 42L include, for example but not limited to, the following reasons. One reason is to allow the electrolytic solution to smoothly permeate the electrode wound bodies 20U and 20L in assembling the secondary battery 1, for example. Another reason is to allow a gas generated when the lithium-ion secondary battery comes into an abnormally hot state or an overcharged state to be easily released to the outside.

The positive electrode current collector 21A may include, for example, an electrically conductive material such as aluminum. The positive electrode current collector 21A may be a metal foil including a material such as aluminum or an aluminum alloy.

The positive electrode active material layer 21B may include, as a positive electrode active material, any one or more of positive electrode materials into which lithium is insertable and from which lithium is extractable. In an embodiment, the positive electrode active material layer 21B may further include any one or more of other materials including, without limitation, a positive electrode binder and a positive electrode conductor. In an embodiment, the positive electrode material may be a lithium-containing compound. In an embodiment, the lithium-containing compound may be, for example but not limited to, a lithium-containing composite oxide or a lithium-containing phosphoric acid compound. The lithium-containing composite oxide may be an oxide including lithium and one or more of other elements, that is, one or more of elements other than lithium, as constituent elements. The lithium-containing composite oxide may have any of crystal structures including, without limitation, a layered rock-salt crystal structure and a spinel crystal structure. The lithium-containing phosphoric acid compound may be a phosphoric acid compound including lithium and one or more of other elements as constituent elements. The lithium-containing phosphoric acid compound may have a crystal structure such as an olivine crystal structure. In an embodiment, the positive electrode active material layer 21B may include, as the positive electrode active material, at least one of lithium cobalt oxide, lithium nickel cobalt manganese oxide, or lithium nickel cobalt aluminum oxide. The positive electrode binder may include, for example, any one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride and polyimide. The positive electrode conductor may include, for example, any one or more of materials including, without limitation, a carbon material. Non-limiting examples of the carbon material may include graphite, carbon black, acetylene black, and Ketjen black. In an embodiment, the positive electrode conductor may be any of electrically conductive materials, and may be, for example but not limited to, a metal material or an electrically conductive polymer.

The negative electrode current collector 22A may include, for example, an electrically conductive material such as copper. The negative electrode current collector 22A may be a metal foil including a material such as nickel, a nickel alloy, copper, or a copper alloy. In an embodiment, a surface of the negative electrode current collector 22A may be roughened. One reason for this is that this helps to improve adherence of the negative electrode active material layer 22B to the negative electrode current collector 22A, owing to what is called an anchor effect. In this case, in an embodiment, the surface of the negative electrode current collector 22A may be roughened at least in a region facing the negative electrode active material layer 22B. Non-limiting examples of a roughening method may include a method in which microparticles are formed through an electrolytic treatment. In the electrolytic treatment, the microparticles may be formed on the surface of the negative electrode current collector 22A by an electrolytic method in an electrolyzer. This may provide the surface of the negative electrode current collector 22A with asperities. A copper foil fabricated by the electrolytic method may be generally called an electrolytic copper foil.

The negative electrode active material layer 22B may include, as a negative electrode active material, any one or more of negative electrode materials into which lithium is insertable and from which lithium is extractable. In an embodiment, the negative electrode active material layer 22B may further include any one or more of other materials including, without limitation, a negative electrode binder and a negative electrode conductor. The negative electrode material may be an electrically conductive material such as a carbon material. One reason for this is that the carbon material exhibits very little change in crystal structure at the time of insertion and extraction of lithium, which helps to stably obtain a high energy density. Another reason is that the carbon material also serves as the negative electrode conductor, which helps to improve an electrically conductive property of the negative electrode active material layer 22B. The carbon material may be, for example but not limited to, graphitizable carbon, non-graphitizable carbon, or graphite. In an embodiment, spacing of a (002) plane of the non-graphitizable carbon may be 0.37 nm or greater. In an embodiment, spacing of a (002) plane of the graphite may be 0.34 nm or less. Non-limiting examples of the carbon material may include pyrolytic carbons, cokes, glassy carbon fibers, an organic polymer compound fired body, activated carbon, and carbon blacks. Non-limiting examples of the cokes may include pitch coke, needle coke, and petroleum coke. The organic polymer compound fired body may be a resultant of firing or carbonizing a polymer compound such as a phenol resin or a furan resin at a suitable temperature. Other than the above, the carbon material may be low-crystalline carbon heat-treated at a temperature of about 1000° C. or lower, or may be amorphous carbon, for example. Note that the carbon material may have any of a fibrous shape, a spherical shape, a granular shape, or a flaky shape. In the secondary battery 1, when an open-circuit voltage in a fully charged state, that is, a battery voltage, is 4.25 V or higher, the amount of extracted lithium per unit mass may increase as compared with when the open-circuit voltage in the fully charged state is 4.20 V, even with the same positive electrode active material. The amount of the positive electrode active material and the amount of the negative electrode active material may be therefore adjusted accordingly. This helps to obtain a high energy density.

In an embodiment, the negative electrode active material layer 22B may include, as the negative electrode active material, a silicon-containing material including at least one of silicon, a silicon oxide, a carbon-silicon compound, or a silicon alloy. The term “silicon-containing material” may be a generic term for a material that includes silicon as a constituent element. Note that the silicon-containing material may include only silicon as the constituent element. Only one kind of silicon-containing material may be used, or two or more kinds of silicon-containing materials may be used. The silicon-containing material may be able to form an alloy with lithium, and may be a simple substance of silicon, a silicon alloy, a silicon compound, a mixture of two or more thereof, or a material including one or more phases thereof. Further, the silicon-containing material may be crystalline or amorphous, or may include both a crystalline part and an amorphous part. Note that the simple substance described here may refer to a simple substance merely in a general sense. The simple substance may thus include a small amount of impurity. In other words, purity of the simple substance is not limited to 100%. The silicon alloy may include, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound may include, as one or more constituent elements other than silicon, any one or more of elements including, without limitation, carbon and oxygen, for example. Note that the silicon compound may include, as one or more constituent elements other than silicon, any one or more of the series of constituent elements described above in relation to the silicon alloy, for example. Non-limiting examples of the silicon alloy and the silicon compound may include SiB₄, SiB₆, Mg₂Si, Ni₂Si, TiSi₂, MoSi₂, CoSi₂, NiSi₂, CaSi₂, CrSi₂, CusSi, FeSi₂, MnSi₂, NbSi₂, TaSi₂, VSi₂, WSi₂, ZnSi₂, SiC, Si₃N₄, Si₂N₂O, and SiOv (where 0<v≤2). Note that the range of v may be chosen as desired, and may be, for example, 0.2<v<1.4.

The separator 23 may be interposed between the positive electrode 21 and the negative electrode 22. The separator 23 may allow lithium ions to pass through and prevent a short circuit of a current caused by contact between the positive electrode 21 and the negative electrode 22. The separator 23 may include, for example, any one or more kinds of porous films each including, for example but not limited to, a synthetic resin or a ceramic. In an embodiment, the separator 23 may be a stacked film including two or more kinds of porous films. Non-limiting examples of the synthetic resin may include polytetrafluoroethylene, polypropylene, and polyethylene. In an embodiment, the separator 23 may include a base that includes a single-layer polyolefin porous film including polyethylene. One reason for this is that this helps to obtain a favorable high output characteristic, as compared with a stacked film. In an embodiment, when each of the first separator member 23A and the second separator member 23B included in the separator 23 is a single-layer porous film including polyolefin, the single-layer porous film including polyolefin may have a thickness of greater than or equal to 10 m and less than or equal to 15 m, for example. Allowing the single-layer porous film including polyolefin to have a thickness of greater than or equal to 10 m helps to sufficiently avoid an internal short circuit. Allowing the single-layer porous film including polyolefin to have a thickness of less than or equal to 15 m helps to achieve a more favorable discharge capacity characteristic. In an embodiment, the single-layer porous film including polyolefin may have a surface density of greater than or equal to 6.3 g/m² and less than or equal to 8.3 g/m², for example. Allowing the single-layer porous film including polyolefin to have a surface density of greater than or equal to 6.3 g/m² helps to sufficiently avoid an internal short circuit. Allowing the single-layer porous film including polyolefin to have a surface density of less than or equal to 8.3 g/m² helps to achieve a more favorable discharge capacity characteristic.

In an embodiment, the separator 23 may include a porous film as the base described above, and a polymer compound layer provided on one of or each of two opposite surfaces of the base. One reason for this is that adherence of the separator 23 to each of the positive electrode 21 and the negative electrode 22 improves, which suppresses distortion of the electrode wound body 20. As a result, the decomposition reaction of the electrolytic solution is suppressed, and leakage of the electrolytic solution with which the base is impregnated is also suppressed. This helps to prevent an easy increase in resistance even upon repeated charging and discharging, and also to suppress swelling of the secondary battery 1. The polymer compound layer may include a polymer compound such as polyvinylidene difluoride. One reason for this is that the polymer compound such as polyvinylidene difluoride has superior physical strength and is electrochemically stable. Note that in an embodiment, the polymer compound may be other than polyvinylidene difluoride. To form the polymer compound layer, for example, a solution in which the polymer compound is dissolved in a solvent such as an organic solvent may be applied on the base, following which the base may be dried. In an embodiment, the base may be immersed in the solution and thereafter dried. In an embodiment, the polymer compound layer may include any one or more kinds of insulating particles such as inorganic particles, for example. Non-limiting examples of the kind of the inorganic particles may include aluminum oxide and aluminum nitride.

The electrolytic solution may include a solvent and an electrolyte salt. In an embodiment, the electrolytic solution may further include any one or more of other materials. Non-limiting examples of the other materials may include an additive. The solvent may include any one or more of nonaqueous solvents including, without limitation, an organic solvent. An electrolytic solution including a nonaqueous solvent may be what is called a nonaqueous electrolytic solution. The nonaqueous solvent may include a fluorine compound and a dinitrile compound, for example. The fluorine compound may include, for example, at least one of fluorinated ethylene carbonate, trifluorocarbonate, trifluoroethyl methyl carbonate, a fluorinated carboxylic acid ester, or a fluorine ether. In an embodiment, the nonaqueous solvent may further include at least one of nitrile compounds other than the dinitrile compound. Non-limiting examples of the nitrile compounds other than the dinitrile compound may include a mononitrile compound and a trinitrile compound. In an embodiment, the dinitrile compound may include succinonitrile (SN). Note that the dinitrile compound is not limited to succinonitrile, and may be any other dinitrile compound such as adiponitrile.

The electrolyte salt may include, for example, any one or more of salts including, without limitation, a lithium salt. In an embodiment, the electrolyte salt may include a salt other than the lithium salt. Non-limiting examples of the salt other than the lithium salt may include a salt of a light metal other than lithium. Non-limiting examples of the lithium salt may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In an embodiment, the lithium salt may include any one or more of LiPF₆, LiBF₄, LiClO₄, or LiAsF₆. In an embodiment, the lithium salt may be LiPF₆. A content of the electrolyte salt is not particularly limited. In an embodiment, the content of the electrolyte salt may be within a range from 0.3 mol/kg to 3 mol/kg both inclusive with respect to the solvent. In an embodiment, when the electrolytic solution includes LiPF₆ as the electrolyte salt, a concentration of LiPF₆ in the electrolytic solution may be within a range from 1.25 mol/kg to 1.45 mol/kg both inclusive. One reason for this is that this helps to prevent cycle deterioration caused by consumption or decomposition of the salt at the time of high load rate charging, and thus helps to improve a high-load cyclability characteristic. In an embodiment, when the electrolytic solution further includes LiBF₄ in addition to LiPF₆ as the electrolyte salt, a concentration of LiBF₄ in the electrolytic solution may be within a range from 0.001 wt % to 0.1 wt % both inclusive. One reason for this is that this helps to more effectively prevent the cycle deterioration caused by consumption or decomposition of the salt at the time of high load rate charging, and thus helps to further improve the high-load cyclability characteristic.

In the secondary battery 1 according to the present an embodiment, for example, upon charging, lithium ions may be extracted from the positive electrode 21, and the extracted lithium ions may be inserted into the negative electrode 22 via the electrolytic solution. In the secondary battery 1, for example, upon discharging, lithium ions may be extracted from the negative electrode 22, and the extracted lithium ions may be inserted into the positive electrode 21 via the electrolytic solution.

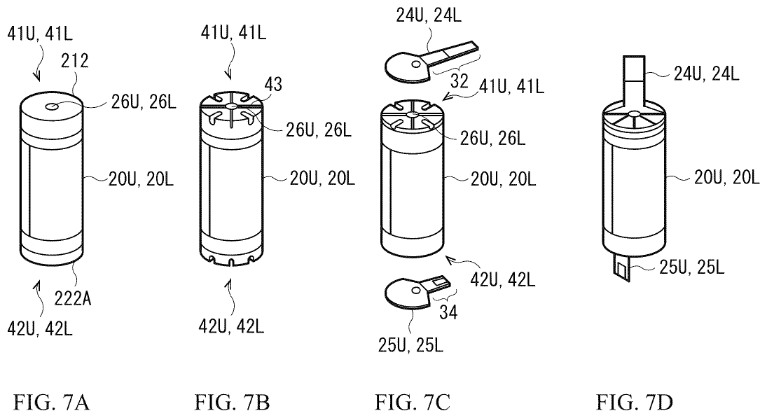

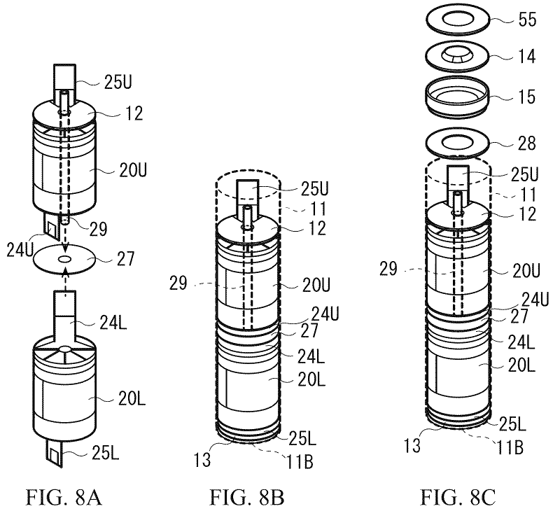

A method of manufacturing the secondary battery 1 will be described with reference to FIGS. 7A to 7D and FIGS. 8A to 8C as well as FIGS. 1 to 6B. FIGS. 7A to 7D and FIGS. 8A to 8C are each a perspective diagram describing a process of manufacturing the secondary battery 1 illustrated in FIG. 1.

First, the electrode wound bodies 20U and 20L may each be fabricated. Each of the electrode wound bodies 20U and 20L may be fabricated by a procedure similar to each other as described below. First, the positive electrode current collector 21A may be prepared, and the positive electrode active material layer 21B may be selectively formed on one of or each of the two opposite surfaces of the positive electrode current collector 21A. Thereafter, the insulating layer 101 may be formed on one of or each of the two opposite surfaces of the positive electrode current collector 21A, along an edge of the positive electrode active material layer 21B, i.e., a border between the positive electrode covered region 211 and the positive electrode exposed region 212. The positive electrode 21 may thus be obtained by the above-described operation. Thereafter, the negative electrode current collector 22A may be prepared, and the negative electrode active material layer 22B may be selectively formed on one of or each of the two opposite surfaces of the negative electrode current collector 22A to thereby form the negative electrode 22 including the negative electrode covered region 221 and the negative electrode exposed region 222. In an embodiment, the positive electrode 21 and the negative electrode 22 may be subjected to a drying process. Thereafter, the positive electrode 21 and the negative electrode 22 may be stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W direction. The stacked body S20 may thus be fabricated. Thereafter, the stacked body S20 may be so wound in a spiral shape as to form the through hole 26. Upon thus winding the stacked body S20, for example, a circular columnar winding core may be used as a jig, and the stacked body S20 may be wound around the circular columnar winding core. In addition, the fixing tape 46 may be attached to an outermost wind of the stacked body S20 wound in the spiral shape, following which the winding core may be removed. Each of the electrode wound bodies 20U and 20L may thus be obtained as illustrated in FIG. 7A.

Thereafter, as illustrated in FIG. 7B, a portion of the first end face 41U and a portion of the second end face 42U of the electrode wound body 20U may each be locally bent by pressing an end of, for example, a 0.5-millimeter-thick flat plate against each of the first end face 41U and the second end face 42U perpendicularly, that is, in the Z-axis direction. A portion of the first end face 41L and a portion of the second end face 42L of the electrode wound body 20L may each be locally bent by pressing an end of, for example, a 0.5-millimeter-thick flat plate against each of the first end face 41L and the second end face 42L perpendicularly, that is, in the Z-axis direction. As a result, grooves 43 may be formed to extend radiately in radial directions (R directions) from the through hole 26U on each of the first end face 41U and the second end face 42U, and grooves 43 may be formed to extend radiately in radial directions (R directions) from the through hole 26L on each of the first end face 41L and the second end face 42L. Note that the number and arrangement of the grooves 43 illustrated in FIG. 7B are merely an example, and an embodiment of the present disclosure is not limited thereto. In an embodiment, the number of the grooves 43 may be any other number, and the grooves 43 may be arranged in any other way.

Thereafter, substantially equal pressures may be applied to the first end face 41U and the second end face 42U in substantially perpendicular directions from above and below the electrode wound body 20U at substantially the same time, and substantially equal pressures may be applied to the first end face 41L and the second end face 42L in substantially perpendicular directions from above and below the electrode wound body 20L at substantially the same time. At this time, for example, a rod-shaped jig may be placed in each of the through holes 26U and 26L in advance. By this operation, as illustrated in FIG. 7C, the positive electrode exposed region 212 and the first part 222A of the negative electrode exposed region 222 in the electrode wound body 20U may be bent to respectively make the first end face 41U and the second end face 42U of the electrode wound body 20U into flat surfaces, and the positive electrode exposed region 212 and the first part 222A of the negative electrode exposed region 222 in the electrode wound body 20L may be bent to respectively make the first end face 41L and the second end face 42L of the electrode wound body 20L into flat surfaces. In an embodiment, at this time, the portions, of the positive electrode edge part 212E of the positive electrode exposed region 212, that are adjacent to each other in the radial direction of each of the electrode wound bodies 20U and 20L may be so bent toward corresponding one of the through holes 26U and 26L as to overlap each other. Similarly, in an embodiment, the portions, of the negative electrode edge part 222E of the negative electrode exposed region 222, that are adjacent to each other in the radial direction of each of the electrode wound bodies 20U and 20L may be so bent toward corresponding one of the through holes 26U and 26L as to overlap each other.

Thereafter, as illustrated in FIG. 7D, the fan-shaped part 31 of the positive electrode current collector plate 24U may be joined to the first end face 41U by a method such as laser welding, and the fan-shaped part 33 of the negative electrode current collector plate 25U may be joined to the second end face 42U by a method such as laser welding. The fan-shaped part 31 of the positive electrode current collector plate 24L may be joined to the first end face 41L by a method such as laser welding, and the fan-shaped part 33 of the negative electrode current collector plate 25L may be joined to the second end face 42L by a method such as laser welding.

Thereafter, as illustrated in FIG. 8A, the insulating plate 12 may be disposed with the negative electrode current collector plate 25U interposed between the insulating plate 12 and the electrode wound body 20U, and the coupling member 29 may be disposed in the through hole 26U of the electrode wound body 20U. Thereafter, a lower end of the coupling member 29 may be coupled to the middle positive electrode current collector plate 27, and the band-shaped part 32 of the positive electrode current collector plate 24U may be coupled to the middle positive electrode current collector plate 27. In addition, the band-shaped part 32 of the positive electrode current collector plate 24L may be coupled to the middle positive electrode current collector plate 27. Accordingly, the electrode wound body 20U and the electrode wound body 20L may be coupled to each other with the middle positive electrode current collector plate 27 interposed therebetween.

Thereafter, the insulating plate 13 may be disposed with the negative electrode current collector plate 25L interposed between the insulating plate 13 and the second end face 42L of the electrode wound body 20L. Thereafter, as illustrated in FIG. 8B, a coupled body in which the electrode wound body 20U, the electrode wound body 20L, and other components are coupled to each other may be placed inside the outer package can 11. Thereafter, the negative electrode current collector plate 25L may be welded to an inner surface of the bottom part 11B of the outer package can 11 by a method such as passing an electrode rod through a through hole of the coupling member 29. Thereafter, the electrolytic solution may be injected into the outer package can 11 to thereby cause the electrode wound bodies 20U and 20L to be impregnated with the electrolytic solution.

Thereafter, as illustrated in FIG. 8C, the coupling member 28 having an annular shape may be coupled to each of the band-shaped part 34 of the negative electrode current collector plate 25U and the inner surface of the narrow part 11S of the outer package can 11. Further, the outer package can 11 may be sealed with the gasket 15, the safety valve mechanism 30, and the battery cover 14, through the use of the narrow part 11S. Thereafter, the outer package can 11 with the washer 55 attached on the battery cover 14 may be covered with the outer package tube 50, following which the outer package tube 50 may be heated by, for example, applying hot air to the outer package tube 50. The outer package tube 50 may thus be contracted and closely attached to the outer surface of the outer package can 11.

The secondary battery 1 according to the present an embodiment may thus be completed.

In the secondary battery 1 according to the an embodiment, the electrode wound body 20U and the electrode wound body 20L are contained inside the outer package body including the battery cover 14 and the outer package can 11, and are disposed adjacent to each other in the Z-axis direction, with the first end face 41U and the first end face 41L being opposed to each other. Accordingly, in the secondary battery 1, for example, a current collection distance is shorter than that when the secondary battery includes one electrode wound body whose dimension in the Z-axis direction is equal to a sum of a dimension of the electrode wound body 20U and a dimension of the electrode wound body 20L, which helps to reduce the internal resistance of the secondary battery 1. The reduction in the internal resistance helps to reduce an amount of heat generation inside the secondary battery 1. This helps to achieve superior battery performance such as allowing the secondary battery 1 to discharge with high output.

In an embodiment, the positive electrode current collector plate 24U coupled to the positive electrode 21 of the electrode wound body 20U and the positive electrode current collector plate 24L coupled to the positive electrode 21 of the electrode wound body 20L may be electrically coupled to each other via the middle positive electrode current collector plate 27, which is the electrically conductive member having the circular plate shape. This makes it possible to enlarge a contact area between the positive electrode current collector plate 24U and the middle positive electrode current collector plate 27 and a contact area between the positive electrode current collector plate 24L and the middle positive electrode current collector plate 27. This helps to further reduce the internal resistance of the secondary battery 1.

In an embodiment, the coupling member 29 may be the cylindrical member or the partially cylindrical member. The cylindrical member or the partially cylindrical member may have a cavity along the Z-axis direction in which the through hole 26U extends. This makes it possible to weld the negative electrode current collector plate 25L to the bottom part 11B with the electrode wound body 20U and the electrode wound body 20L coupled to each other in advance in the manufacturing process of the secondary battery 1. This helps to increase the degree of freedom of operation in the manufacturing process.

In an embodiment, for example, the band-shaped part 34 of the negative electrode current collector plate 25U coupled to the electrode wound body 20U may be coupled to the outer package can 11 via the coupling member 28 having the annular shape. This helps to reduce a coupling resistance between the negative electrode current collector plate 25U and the outer package can 11 as compared with, for example, when the band-shaped part 34 of the negative electrode current collector plate 25U is directly coupled to the outer package can 11. This helps to further reduce the internal resistance of the secondary battery 1.

In an embodiment, the secondary battery 1 may include a lithium-ion secondary battery. This helps to allow a sufficient battery capacity to be obtained stably through insertion and extraction of lithium. This helps to achieve higher operation reliability.

Non-limiting examples of applications of the secondary battery 1 according to the an embodiment of the present disclosure may be as described below.

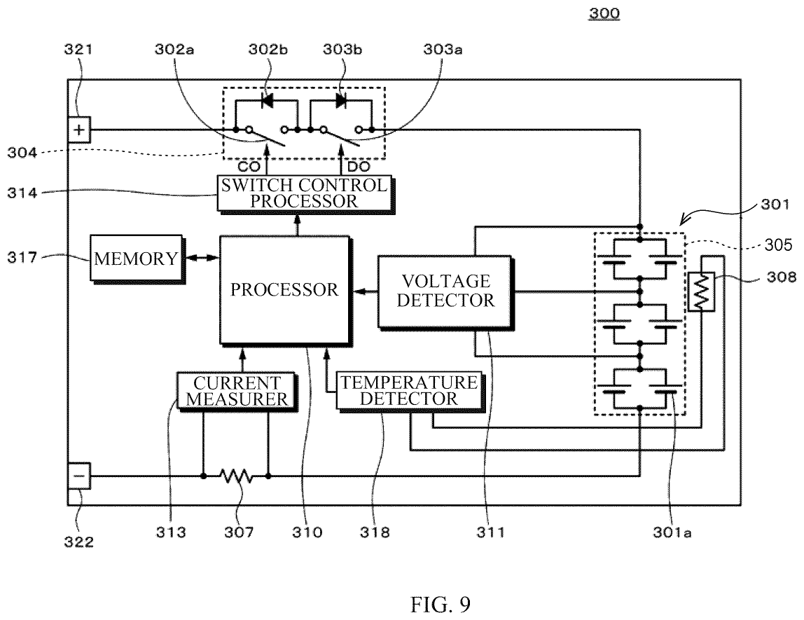

FIG. 9 is a block diagram illustrating a circuit configuration example in which the secondary battery 1 according to an embodiment of the present disclosure is applied to a battery pack 300. The battery pack 300 may include an assembled battery 301, a switcher 304, an outer package member 305, a current detection resistor 307, a temperature detection device 308, and a processor 310. The switcher 304 may include a charge control switch 302a and a discharge control switch 303a. The outer package member 305 may contain the assembled battery 301.

The battery pack 300 may include a positive electrode terminal 321 and a negative electrode terminal 322. Upon charging, the positive electrode terminal 321 and the negative electrode terminal 322 may be respectively coupled to a positive electrode terminal and a negative electrode terminal of a charger to perform charging. Upon use of electronic equipment, the positive electrode terminal 321 and the negative electrode terminal 322 may be respectively coupled to a positive electrode terminal and a negative electrode terminal of the electronic equipment to perform discharging.

The assembled battery 301 may include secondary batteries 301a coupled in series or in parallel. The secondary battery 1 described above is applicable to each of the secondary batteries 301a. FIG. 9 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration, where each of n and m is an integer.

The switcher 304 may include the charge control switch 302a, a diode 302b, the discharge control switch 303a, and a diode 303b, and may be controlled by the processor 310. The diode 302b may have a polarity that is in a reverse direction with respect to a charge current flowing in a direction from the positive electrode terminal 321 to the assembled battery 301, and that is in a forward direction with respect to a discharge current flowing in a direction from the negative electrode terminal 322 to the assembled battery 301. The diode 303b may have a polarity that is in the forward direction with respect to the charge current and in the reverse direction with respect to the discharge current. In FIG. 9, the switcher 304 may be provided on a positive side; however, in an embodiment, the switcher 304 may be provided on a negative side.

The charge control switch 302a may be so controlled by a charge and discharge control processor that when the battery voltage reaches an overcharge detection voltage, the charge control switch 302a is turned off to thereby prevent the charge current from flowing through a current path of the assembled battery 301. After the charge control switch 302a is turned off, simply discharging may be enabled through the diode 302b. Further, the charge control switch 302a may be so controlled by the processor 310 that when a large current flows upon charging, the charge control switch 302a is turned off to thereby block the charge current flowing through the current path of the assembled battery 301. The discharge control switch 303a may be so controlled by the processor 310 that when the battery voltage reaches an overdischarge detection voltage, the discharge control switch 303a is turned off to thereby prevent the discharge current from flowing through the current path of the assembled battery 301. After the discharge control switch 303a is turned off, simply charging may be enabled through the diode 303b. Further, the discharge control switch 303a may be so controlled by the processor 310 that when a large current flows upon discharging, the discharge control switch 303a is turned off to thereby block the discharge current flowing through the current path of the assembled battery 301.

The temperature detection device 308 may be, for example but not limited to, a thermistor. The temperature detection device 308 may be provided in the vicinity of the assembled battery 301. The temperature detection device 308 may measure a temperature of the assembled battery 301 and may supply data regarding the measured temperature to the processor 310. A voltage detector 311 may measure a voltage of the assembled battery 301 and a voltage of each of the secondary batteries 301a included therein, may perform A/D conversion on the measured voltages, and may supply data regarding the converted voltages to the processor 310. A current measurer 313 may measure a current by means of the current detection resistor 307 and may supply data regarding the measured current to the processor 310. A switch control processor 314 may control the charge control switch 302a and the discharge control switch 303a of the switcher 304, based on data regarding the voltages supplied from the voltage detector 311 and data regarding the current supplied from the current measurer 313.

When a voltage of any of the secondary batteries 301a reaches the overcharge detection voltage or below, or reaches the overdischarge detection voltage or below, or when a large current flows suddenly, the switch control processor 314 may transmit a control signal to the switcher 304 to thereby prevent overcharging and overdischarging, and overcurrent charging and discharging. For example, when the secondary battery is a lithium-ion secondary battery, the overcharge detection voltage may be determined to be, for example, 4.20 V±0.05 V, and the overdischarge detection voltage may be determined to be, for example, 2.4 V±0.1 V.

As the charge control switch 302a and the discharge control switch 303a, for example, semiconductor switches such as metal-oxide-semiconductor field-effect transistors (MOSFETs) may be used. In this case, parasitic diodes of the MOSFETs may serve as the diodes 302b and 303b. When P-channel FETs are used as the charge control switch 302a and the discharge control switch 303a, the switch control processor 314 may supply control signals DO and CO to a gate of the charge control switch 302a and a gate of the discharge control switch 303a, respectively. When the charge control switch 302a and the discharge control switch 303a are of a P-channel type, the charge control switch 302a and the discharge control switch 303a may each be turned on by a gate potential that is lower than a source potential by a predetermined value or more. For example, in normal charging and discharging operations, the control signals CO and DO may be set to a low level to turn on the charge control switch 302a and the discharge control switch 303a.

For example, upon overcharging or overdischarging, the control signals CO and DO may be set to a high level to turn off the charge control switch 302a and the discharge control switch 303a.

A memory 317 may include a random-access memory (RAM) and a read only memory (ROM). For example, the memory 317 may include a nonvolatile memory such as an erasable programmable read only memory (EPROM). In the memory 317, values including, without limitation, numerical values calculated by the processor 310 and a battery's internal resistance value of each of the secondary batteries 301a in an initial state measured in the manufacturing process stage, may be stored in advance and may be rewritable on an as-needed basis. Further, storing data regarding a full charge capacity of the secondary battery 301a in the memory 317 allows the processor 310 to calculate, for example, a remaining capacity.

A temperature detector 318 may measure a temperature with use of the temperature detection device 308, may perform charge and discharge control upon abnormal heat generation, and may perform correction in calculating the remaining capacity.

The above-described secondary battery 1 according to the an embodiment of the present disclosure is mountable on, or usable to supply electric power to, for example, any of equipment including, without limitation, electronic equipment, an electric vehicle, an electric aircraft, and a power storage apparatus.

Non-limiting examples of the electronic equipment may include laptop personal computers, smartphones, tablet terminals, personal digital assistants (PDAs) as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, traffic lights, and any other electronic equipment to which any embodiment of the present disclosure is applicable.

Non-limiting examples of the electric vehicle may include railway vehicles, golf carts, electric carts, electric automobiles including hybrid electric automobiles, and any other electric vehicle to which any embodiment of the present disclosure is applicable. The secondary battery 1 may be used as a driving power source or an auxiliary power source for any of these electric vehicles. Non-limiting examples of the power storage apparatuses may include a power storage power source for architectural structures including residential houses, or for power generation facilities, and any other power storage apparatus to which any embodiment of the present disclosure is applicable.

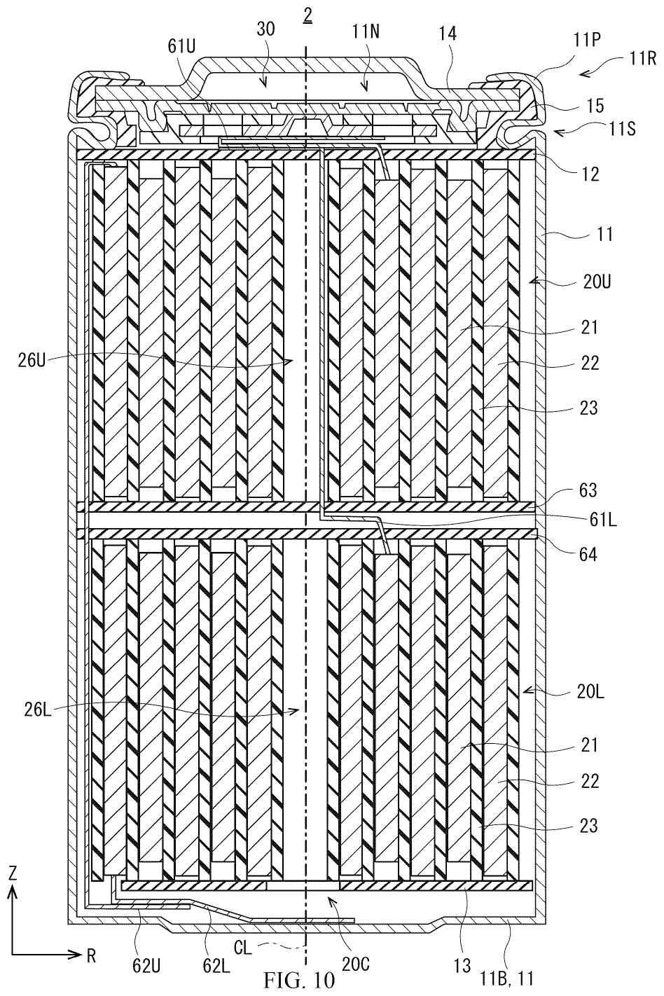

Next, a description is given of a secondary battery 2 according to a modification example of an embodiment of the present disclosure. FIG. 10 illustrates a vertical sectional structure, along a height direction, of the secondary battery 2 according to the modification example of the an embodiment of the present disclosure. In FIG. 10, components substantially the same as those of the secondary battery 1 illustrated in FIG. 1 are denoted by the same reference signs as those of the secondary battery 1. The secondary battery 2 may include positive electrode tabs 61U and 61L instead of the positive electrode current collector plates 24U and 24L, and include negative electrode tabs 62U and 62L instead of the negative electrode current collector plates 25U and 25L. Insulating plates 63 and 64 may further be provided between the electrode wound body 20U and the electrode wound body 20L. The positive electrode tab 61U may electrically couple the positive electrode 21 of the electrode wound body 20U and the battery cover 14 to each other. The battery cover 14 may serve as a positive electrode terminal. Similarly, the positive electrode tab 61L may electrically couple the positive electrode 21 of the electrode wound body 20L and the battery cover 14 to each other. In addition, the negative electrode tab 62U may electrically couple the negative electrode 22 of the electrode wound body 20U and the bottom part 11B of the outer package can 11 to each other. The bottom part 11B of the outer package can 11 may serve as a negative electrode terminal. Similarly, the negative electrode tab 62L may electrically couple the negative electrode 22 of the electrode wound body 20L and the bottom part 11B of the outer package can 11 to each other.

In the secondary battery 2 according to the present modification example, the electrode wound body 20U and the electrode wound body 20L are contained inside the outer package body including the battery cover 14 and the outer package can 11, and are disposed adjacent to each other in the Z-axis direction, with the first end face 41U and the first end face 41L being opposed to each other. Accordingly, in the secondary battery 2, for example, the current collection distance is shorter than that when the secondary battery includes one electrode wound body whose dimension in the Z-axis direction is equal to the sum of the dimension of the electrode wound body 20U and the dimension of the electrode wound body 20L, which helps to reduce the internal resistance of the secondary battery 2. The reduction in the internal resistance helps to reduce an amount of heat generation inside the secondary battery 2. This helps to achieve superior battery performance such as allowing the secondary battery 2 to discharge with high output.

### EXAMPLES

A description is given of Examples according to an an embodiment of the present disclosure.

### [Fabrication Method]

### Example 1

As described below, the cylindrical secondary battery illustrated in FIG. 1, etc. was fabricated. Here, a lithium-ion secondary battery was fabricated with dimensions of 21 mm in diameter and 70 mm in length in nominal values.

First, an aluminum foil having a thickness of 12 m was prepared as the positive electrode current collector 21A. Thereafter, a layered lithium oxide as the positive electrode active material was mixed with a positive electrode binder and a conductive additive to thereby obtain a positive electrode mixture. The layered lithium oxide included lithium nickel cobalt aluminum oxide (NCA) having a Ni ratio of 85% or greater. The positive electrode binder included polyvinylidene difluoride. The conductive additive included a mixture of carbon black, acetylene black, and Ketjen black. A mixture ratio between the positive electrode active material, the positive electrode binder, and the conductive additive was set to 96.4:2:1.6. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on respective predetermined regions of the two opposite surfaces of the positive electrode current collector 21A by means of a coating apparatus, following which the applied positive electrode mixture slurry was dried to thereby form the positive electrode active material layers 21B. Further, a coating material including polyvinylidene difluoride (PVDF) was applied on two opposite surfaces in the positive electrode exposed region 212, at respective regions adjacent to the positive electrode covered region 211. The applied coating material was dried to thereby form the insulating layers 101 each having a width of 3 mm and a thickness of 8 m. Thereafter, the positive electrode active material layers 21B were compression-molded by means of a roll pressing machine. Thus, the positive electrode 21 including the positive electrode covered region 211 and the positive electrode exposed region 212 was obtained. Thereafter, the positive electrode 21 was subjected to shearing to set a width of the positive electrode exposed region 212 in the W direction to 7 mm. Further, a length of the positive electrode 21 in the L direction was set to 1700 mm.

Further, a copper foil having a thickness of 8 m was prepared as the negative electrode current collector 22A. Thereafter, the negative electrode active material was mixed with a negative electrode binder and a conductive additive to thereby obtain a negative electrode mixture. The negative electrode active material included a mixture of a carbon material including graphite and SiO. The negative electrode binder included polyvinylidene difluoride. The conductive additive included a mixture of carbon black, acetylene black, and Ketjen black. A mixture ratio between the negative electrode active material, the negative electrode binder, and the conductive additive was set to 96.1:2.9:1.0. A mixture ratio between graphite and SiO in the negative electrode active material was set to 95:5. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on respective predetermined regions of the two opposite surfaces of the negative electrode current collector 22A by means of a coating apparatus, following which the applied negative electrode mixture slurry was dried to thereby form the negative electrode active material layers 22B. Thereafter, the negative electrode active material layers 22B were compression-molded by means of a roll pressing machine. The negative electrode 22 including the negative electrode covered region 221 and the negative electrode exposed region 222 was thus obtained. Thereafter, the negative electrode 22 was subjected to shearing to set a width of the first part 222A of the negative electrode exposed region 222 in the W direction to 4 mm. Further, a length of the negative electrode 22 in the L direction was set to 1760 mm.

Thereafter, the positive electrode 21 and the negative electrode 22 were so stacked on each other with the first separator member 23A and the second separator member 23B on the positive electrode 21 and the negative electrode 22, respectively, as to allow the positive electrode exposed region 212 and the first part 222A of the negative electrode exposed region 222 to be on opposite sides to each other in the W direction. The stacked body S20 was thus fabricated. At this time, the stacked body S20 was fabricated not to allow the positive electrode active material layers 21B to protrude from the negative electrode active material layers 22B in the W direction. As the first separator member 23A and the second separator member 23B, polyethylene sheets each having a width of 65 mm and a thickness of 5 m were used. Thereafter, the stacked body S20 was so wound in a spiral shape as to form the through hole 26, and the fixing tape 46 was attached to the outermost wind of the stacked body S20 thus wound. As described above, each of the electrode wound bodies 20U and 20L was obtained.

Thereafter, the first end face 41U and the second end face 42U of the electrode wound body 20U were each locally bent by pressing an end of a 0.5-millimeter-thick flat plate against each of the first end face 41U and the second end face 42U in the Z-axis direction to thereby form the grooves 43 extending radiately in the radial directions (i.e., the R directions) from the through hole 26U; and the first end face 41L and the second end face 42L of the electrode wound body 20L were each locally bent by pressing an end of a 0.5-millimeter-thick flat plate against each of the first end face 41L and the second end face 42L in the Z-axis direction to thereby form the grooves 43 extending radiately in the radial directions (i.e., the R directions) from the through hole 26L.

Thereafter, substantially equal pressures were applied to the first end face 41U and the second end face 42U in substantially perpendicular directions from above and below the electrode wound body 20U at substantially the same time; and substantially equal pressures were applied to the first end face 41L and the second end face 42L in substantially perpendicular directions from above and below the electrode wound body 20L at substantially the same time. By this operation, the positive electrode exposed region 212 and the first part 222A of the negative electrode exposed region 222 in the electrode wound body 20U were bent to respectively make the first end face 41U and the second end face 42U of the electrode wound body 20U into flat surfaces; and the positive electrode exposed region 212 and the first part 222A of the negative electrode exposed region 222 in the electrode wound body 20L were bent to respectively make the first end face 41L and the second end face 42L of the electrode wound body 20L into flat surfaces. At this time, in each of the electrode wound bodies 20U and 20L, portions of the positive electrode edge part 212E of the positive electrode exposed region 212 at corresponding one of the first end faces 41U and 41L were so bent toward corresponding one of the through holes 26U and 26L as to overlap each other; and portions of the negative electrode edge part 222E of the negative electrode exposed region 222 at corresponding one of the second end faces 42U and 42L were so bent toward corresponding one of the through holes 26U and 26L as to overlap each other. Thereafter, the fan-shaped part 31 of corresponding one of the positive electrode current collector plates 24U and 24L was joined to corresponding one of the first end faces 41U and 41L by laser welding; and the fan-shaped part 33 of corresponding one of the negative electrode current collector plates 25U and 25L was joined to corresponding one of the second end faces 42U and 42L by laser welding. Each of the positive electrode current collector plates 24U and 24L was used that included the fan-shaped part 31 provided with the opening 35 having an inner diameter D35 of 4.0 mm.

Thereafter, the band-shaped part 34 of the negative electrode current collector plate 25U was bent and passed through a hole of the insulating plate 12. Further, the band-shaped part 34 of the negative electrode current collector plate 25L was bent and passed through a hole of the insulating plate 13.

Thereafter, the lower end of the coupling member 29 was coupled to the middle positive electrode current collector plate 27, the band-shaped part 32 of the positive electrode current collector plate 24U was coupled to the middle positive electrode current collector plate 27, and the band-shaped part 32 of the positive electrode current collector plate 24L was coupled to the middle positive electrode current collector plate 27. Accordingly, the electrode wound body 20U and the electrode wound body 20L were coupled to each other with the middle positive electrode current collector plate 27 interposed therebetween.

Thereafter, a coupled body in which the electrode wound body 20U, the electrode wound body 20L, and other components were coupled to each other were placed inside the outer package can 11. Note that the outer package can 11 had an inner diameter of 20.80 mm±0.05 mm. Thereafter, the negative electrode current collector plate 25L was welded to the inner surface of the bottom part 11B of the outer package can 11 by passing the electrode rod through the through hole of the coupling member 29. Thereafter, the electrolytic solution was injected into the outer package can 11 to thereby cause the electrode wound bodies 20U and 20L to be impregnated with the electrolytic solution. As the electrolytic solution, used was a solution including: a solvent in which fluoroethylene carbonate (FEC) and succinonitrile (SN) were added to a major solvent, i.e., ethylene carbonate (EC) and dimethyl carbonate (DMC); and LiBF₄ and LiPF₆ as the electrolyte salt. In the lithium-ion secondary battery of Example 1, a content ratio (wt %) between EC, DMC, FEC, SN, LiBF₄, and LiPF₆ in the electrolytic solution was set to 12.7:56.2:12.0:1.0:1.0:17.1.

Thereafter, the coupling member 28 having the annular shape was coupled to each of the band-shaped part 34 of the negative electrode current collector plate 25U and the inner surface of the narrow part 11S of the outer package can 11. Further, the outer package can 11 was sealed with the gasket 15, the safety valve mechanism 30, and the battery cover 14, through the use of the narrow part 11S. Thereafter, the outer package can 11 with the washer 55 attached on the battery cover 14 was covered with the outer package tube 50, following which the outer package tube 50 was heated by applying hot air to the outer package tube 50. The outer package tube 50 was thus contracted and closely attached to the outer surface of the outer package can 11.

The secondary battery 1 of Example 1 was thus obtained.

### Comparative Example 1

As Comparative example 1, a secondary battery was fabricated that included one electrode wound body 20 instead of the electrode wound body 20U and the electrode wound body 20L that were provided as two separate pieces.

### [Evaluation of Battery Characteristic]

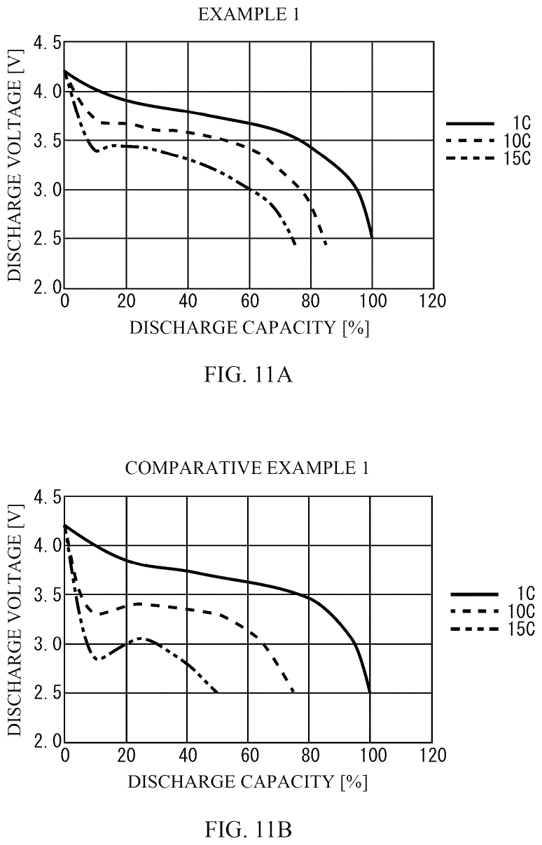

Each of the secondary batteries of Example 1 and Comparative example 1 obtained as described above was examined in terms of a discharge load characteristic. The results are presented in FIGS. 11A and 11B.

FIG. 11A is a characteristic diagram illustrating a relationship between a discharge capacity and a discharge voltage of the secondary battery of Example 1. FIG. 11B is a characteristic diagram illustrating a relationship between a discharge capacity and a discharge voltage of the secondary battery of Comparative example 1. In FIGS. 11A and 11B, a horizontal axis represents a discharge capacity [%], and a vertical axis represents a discharge voltage [V]. Note that the discharge capacity on the horizontal axis is a value normalized with respect to the discharge capacity with a rated current of 1C assumed to be 100%. When each of the secondary batteries of Example 1 and Comparative example 1 was discharged with each of currents of 1 C, 10 C, and 15 C, the changes illustrated in FIGS. 11A and 11B were observed.

As is clear from a comparison between FIGS. 11A and 11B, a large difference was not observed between Example 1 and Comparative example 1 for a behavior in discharging with a current of 1 C, but a difference between Example 1 and Comparative example 1 became significant when the secondary batteries were discharged with currents of 10 C and 15 C. For example, when the output was increased, it was possible to suppress a decrease in the discharge voltage in Example 1 as compared with Comparative example 1.

The results described above demonstrated that the secondary battery of an embodiment of the present disclosure made it possible to reduce the internal resistance, thereby reducing the amount of heat generated inside the secondary battery and allowing the secondary battery to discharge with high output.

Although the present disclosure has been described hereinabove with reference to an embodiment and modification examples, a configuration of any embodiment of the present disclosure is not limited to the configurations described in relation to the an embodiment and modification examples, and is therefore modifiable in a variety of ways. For example, two electrode wound bodies may be so positioned that the first end faces are opposed to each other. The first end surfaces may be where the respective positive electrodes of the electrode wound bodies are exposed. However, an embodiment of the present disclosure is not limited to the above-described configuration. In an embodiment, two electrode wound bodies may be so positioned that the second end faces are opposed to each other. The second end faces may be where the respective negative electrodes of the electrode wound bodies are exposed.

For example, the description has been given of the case where the electrode reactant is lithium; however, the electrode reactant is not particularly limited. In an embodiment, the electrode reactant may be another alkali metal such as sodium or potassium. In an embodiment, the electrode reactant may be an alkaline earth metal such as beryllium, magnesium, or calcium, as described above. In an embodiment, the electrode reactant may be another light metal such as aluminum.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described an embodiment of the present disclosure.

(1)

A secondary battery including:
a first electrode wound body and a second electrode wound body each including a wound structure and each having a through hole, the wound structure including a stacked body that includes a first electrode, a second electrode, and a separator and that is wound along a longitudinal direction of the stacked body, the through hole being provided through corresponding one of the first electrode wound body and the second electrode wound body in a width direction of the stacked body orthogonal to the longitudinal direction; and
an outer package body containing the first electrode wound body and the second electrode wound body, in which
each of the first electrode wound body and the second electrode wound body includes, at respective ends of the stacked body in the width direction, a first end face at which the first electrode is exposed and a second end face at which the second electrode is exposed, and
the first electrode wound body and the second electrode wound body are disposed adjacent to each other in the width direction of the stacked body, with the first end face of the first electrode wound body and the first end face of the second electrode wound body being opposed to each other.
   (2)

The secondary battery according to (1), in which the first electrode wound body and the second electrode wound body are disposed adjacent to each other with the through hole of the first electrode wound body and the through hole of the second electrode wound body communicating each other.

(3)

The secondary battery according to (1) or (2), in which
the outer package body includes
   a first bottom part and a second bottom part opposed to each other with the first electrode wound body and the second electrode wound body interposed between the first bottom part and the second bottom part in the width direction of the stacked body, and
   a wall part positioned between the first bottom part and the second bottom part, the wall part surrounding the first electrode wound body and the second electrode wound body,
the first bottom part is opposed to the second end face of the first electrode wound body, and
the second bottom part is opposed to the second end face of the second electrode wound body.
   (4)

The secondary battery according to any one of (1) to (3), further including:
a primary first electrode current collector plate opposed to the first end face of the first electrode wound body;
a secondary first electrode current collector plate opposed to the first end face of the second electrode wound body;
a primary second electrode current collector plate opposed to the second end face of the first electrode wound body; and
a secondary second electrode current collector plate opposed to the second end face of the second electrode wound body.
   (5)

The secondary battery according to (4), in which
the first electrode of each of the first electrode wound body and the second electrode wound body includes
   a first electrode active material layer extending in both the longitudinal direction and the width direction, and
   a first electrode current collector including a first electrode covered region and a first electrode exposed region, the first electrode covered region being covered with the first electrode active material layer, the first electrode exposed region being not covered with the first electrode active material layer and extending in the width direction from the first electrode active material layer, and
the first end face includes an edge part, of the first electrode exposed region, that is bent toward the through hole with the corresponding one of the first electrode wound body and the second electrode wound body being wound.
   (6)

The secondary battery according to (5), in which all or a part of the first electrode exposed region of the first electrode wound body is included in the first end face of the first electrode wound body and coupled to the primary first electrode current collector plate, and all or a part of the first electrode exposed region of the second electrode wound body is included in the first end face of the second electrode wound body and coupled to the secondary first electrode current collector plate.

(7)

The secondary battery according to (5) or (6), in which
the second electrode of each of the first electrode wound body and the second electrode wound body includes
   a second electrode active material layer extending in both the longitudinal direction and the width direction, and
   a second electrode current collector including a second electrode covered region and a second electrode exposed region, the second electrode covered region being covered with the second electrode active material layer, the second electrode exposed region being not covered with the second electrode active material layer and extending in the width direction from the second electrode active material layer, and
the second end face includes an edge part, of the second electrode exposed region, that is bent toward the through hole with the corresponding one of the first electrode wound body and the second electrode wound body being wound.
   (8)

The secondary battery according to (7), in which all or a part of the second electrode exposed region of the first electrode wound body is included in the second end face of the first electrode wound body and coupled to the primary second electrode current collector plate, and all or a part of the second electrode exposed region of the second electrode wound body is included in the second end face of the second electrode wound body and coupled to the secondary second electrode current collector plate.

(9)

The secondary battery according to (4), in which
the outer package body includes a cover part and a container part, the cover part being electrically coupled to the primary first electrode current collector plate and the secondary first electrode current collector plate, the container part being electrically coupled to the primary second electrode current collector plate and the secondary second electrode current collector plate,
the container part includes a bottom part and a wall part, the wall part being provided along an outer edge of the bottom part, standing in the width direction and surrounding the first electrode wound body and the second electrode wound body, the wall part including an open end part through which the first electrode wound body and the second electrode wound body are passable, the open end part being on an opposite side to the bottom part, and
the cover part closes the open end part of the container part.
   (10)

The secondary battery according to (9), in which
the primary second electrode current collector plate is provided between the cover part and the second end face of the first electrode wound body, and
the secondary second electrode current collector plate is provided between the bottom part and the second end face of the second electrode wound body.
   (11)

The secondary battery according to (9) or (10), further including
a first coupling member electrically coupling the cover part and each of the primary first electrode current collector plate and the secondary first electrode current collector plate, in which
the first coupling member is disposed in the through hole of the first electrode wound body.
   (12)

The secondary battery according to (11), in which the first coupling member includes a cylindrical member with a height direction of the cylindrical member extending in the width direction of the stacked body, or a partially cylindrical member having a slit in a portion of the cylindrical member with the height direction of the cylindrical member extending in the width direction of the stacked body.

(13)

The secondary battery according to any one of (9) to (12), further including
a second coupling member electrically coupling the container part and the primary second electrode current collector plate, in which
the second coupling member includes an annular member coupled to an inner surface of the container part.
   (14)

A battery pack including:
the secondary battery according to any one of (1) to (13);
a processor configured to control the secondary battery; and
an outer package member containing the secondary battery.

According to a secondary battery of at least an embodiment of the present disclosure and a battery pack including the secondary battery of at least an embodiment of the present disclosure, a first electrode wound body and a second electrode wound body are contained inside an outer package body and are disposed adjacent to each other, with a first end face of the first electrode wound body and a first end face of the second electrode wound body being opposed with each other. This reduces a current collection distance in the secondary battery, which helps to reduce an internal resistance. The reduction in the internal resistance helps to reduce an amount of heat generation inside the secondary battery. This allows the secondary battery to discharge with high output, and helps to achieve superior battery performance.

Note that effects of an embodiment of the present disclosure are not necessarily limited to the example effects described above and may include any of a series of effects described herein in relation to an embodiment of the present disclosure and the modification examples thereof.

Although the present disclosure has been described hereinabove in terms of an embodiment and modification examples, the present disclosure is not limited thereto. It should be appreciated that variations may be made in the described an embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a first electrode wound body and a second electrode wound body each including a wound structure and each having a through hole, the wound structure including a stacked body that includes a first electrode, a second electrode, and a separator and that is wound along a longitudinal direction of the stacked body, the through hole being provided through corresponding one of the first electrode wound body and the second electrode wound body in a width direction of the stacked body orthogonal to the longitudinal direction; and
an outer package body containing the first electrode wound body and the second electrode wound body, wherein
each of the first electrode wound body and the second electrode wound body includes, at respective ends of the stacked body in the width direction, a first end face at which the first electrode is exposed and a second end face at which the second electrode is exposed, and
the first electrode wound body and the second electrode wound body are disposed adjacent to each other in the width direction of the stacked body, with the first end face of the first electrode wound body and the first end face of the second electrode wound body being opposed to each other.

2. The secondary battery according to claim 1, wherein the first electrode wound body and the second electrode wound body are disposed adjacent to each other with the through hole of the first electrode wound body and the through hole of the second electrode wound body communicating each other.

3. The secondary battery according to claim 1, wherein
the outer package body includes
a first bottom part and a second bottom part opposed to each other with the first electrode wound body and the second electrode wound body interposed between the first bottom part and the second bottom part in the width direction of the stacked body, and
a wall part positioned between the first bottom part and the second bottom part, the wall part surrounding the first electrode wound body and the second electrode wound body,
the first bottom part is opposed to the second end face of the first electrode wound body, and
the second bottom part is opposed to the second end face of the second electrode wound body.

4. The secondary battery according to claim 1, further comprising:
a primary first electrode current collector plate opposed to the first end face of the first electrode wound body;
a secondary first electrode current collector plate opposed to the first end face of the second electrode wound body;
a primary second electrode current collector plate opposed to the second end face of the first electrode wound body; and
a secondary second electrode current collector plate opposed to the second end face of the second electrode wound body.

5. The secondary battery according to claim 4, wherein
the first electrode of each of the first electrode wound body and the second electrode wound body includes
a first electrode active material layer extending in both the longitudinal direction and the width direction, and
a first electrode current collector including a first electrode covered region and a first electrode exposed region, the first electrode covered region being covered with the first electrode active material layer, the first electrode exposed region being not covered with the first electrode active material layer and extending in the width direction from the first electrode active material layer, and
the first end face comprises an edge part, of the first electrode exposed region, that is bent toward the through hole with the corresponding one of the first electrode wound body and the second electrode wound body being wound.

6. The secondary battery according to claim 5, wherein all or a part of the first electrode exposed region of the first electrode wound body is included in the first end face of the first electrode wound body and coupled to the primary first electrode current collector plate, and all or a part of the first electrode exposed region of the second electrode wound body is included in the first end face of the second electrode wound body and coupled to the secondary first electrode current collector plate.

7. The secondary battery according to claim 5, wherein
the second electrode of each of the first electrode wound body and the second electrode wound body includes
a second electrode active material layer extending in both the longitudinal direction and the width direction, and
a second electrode current collector including a second electrode covered region and a second electrode exposed region, the second electrode covered region being covered with the second electrode active material layer, the second electrode exposed region being not covered with the second electrode active material layer and extending in the width direction from the second electrode active material layer, and
the second end face comprises an edge part, of the second electrode exposed region, that is bent toward the through hole with the corresponding one of the first electrode wound body and the second electrode wound body being wound.

8. The secondary battery according to claim 7, wherein all or a part of the second electrode exposed region of the first electrode wound body is included in the second end face of the first electrode wound body and coupled to the primary second electrode current collector plate, and all or a part of the second electrode exposed region of the second electrode wound body is included in the second end face of the second electrode wound body and coupled to the secondary second electrode current collector plate.

9. The secondary battery according to claim 4, wherein
the outer package body includes a cover part and a container part, the cover part being electrically coupled to the primary first electrode current collector plate and the secondary first electrode current collector plate, the container part being electrically coupled to the primary second electrode current collector plate and the secondary second electrode current collector plate,
the container part includes a bottom part and a wall part, the wall part being provided along an outer edge of the bottom part, standing in the width direction and surrounding the first electrode wound body and the second electrode wound body, the wall part including an open end part through which the first electrode wound body and the second electrode wound body are passable, the open end part being on an opposite side to the bottom part, and
the cover part closes the open end part of the container part.

10. The secondary battery according to claim 9, wherein
the primary second electrode current collector plate is provided between the cover part and the second end face of the first electrode wound body, and
the secondary second electrode current collector plate is provided between the bottom part and the second end face of the second electrode wound body.

11. The secondary battery according to claim 9, further comprising
a first coupling member electrically coupling the cover part and each of the primary first electrode current collector plate and the secondary first electrode current collector plate, wherein
the first coupling member is disposed in the through hole of the first electrode wound body.

12. The secondary battery according to claim 11, wherein the first coupling member comprises a cylindrical member with a height direction of the cylindrical member extending in the width direction of the stacked body, or a partially cylindrical member having a slit in a portion of the cylindrical member with the height direction of the cylindrical member extending in the width direction of the stacked body.

13. The secondary battery according to claim 9, further comprising
a second coupling member electrically coupling the container part and the primary second electrode current collector plate, wherein
the second coupling member comprises an annular member coupled to an inner surface of the container part.

14. A battery pack comprising:
a secondary battery;
a processor configured to control the secondary battery; and
an outer package member containing the secondary battery,
the secondary battery including
a first electrode wound body and a second electrode wound body each including a wound structure and each having a through hole, the wound structure including a stacked body that includes a first electrode, a second electrode, and a separator and that is wound along a longitudinal direction of the stacked body, the through hole being provided through corresponding one of the first electrode wound body and the second electrode wound body in a width direction of the stacked body orthogonal to the longitudinal direction, and
an outer package body containing the first electrode wound body and the second electrode wound body, wherein
each of the first electrode wound body and the second electrode wound body includes, at respective ends of the stacked body in the width direction, a first end face at which the first electrode is exposed and a second end face at which the second electrode is exposed, and
the first electrode wound body and the second electrode wound body are disposed adjacent to each other in the width direction of the stacked body, with the first end face of the first electrode wound body and the first end face of the second electrode wound body being opposed to each other.
